(19) United States
(12) Patent Application Publication
(10) Pub. No.: US 2012/0161451 A1
(43) Pub. Date: Jun. 28, 2012

(54) PRODUCTION OF LIQUID FUEL OR ELECTRIC POWER FROM SYNTHESIS GAS IN AN INTEGRATED PLATFORM

(75) Inventors: Douglas Struble, Maumee, OH (US); Robert Schuetzle, Sacramento, CA (US)

(73) Assignee: SYNTERRA ENERGY, Maumee, OH (US)

(21) Appl. No.: 13/333,486

(22) Filed: Dec. 21, 2011

Related U.S. Application Data
(60) Provisional application No. 61/426,303, filed on Dec. 22, 2010.

(51) Int. Cl. C10L 1/04; G01N 35/00; H02K 7/18; B01J 19/00

(52) U.S. Cl. 290/1 R; 585/899; 585/800; 422/600; 422/187; 422/50; 422/83

(57) ABSTRACT

System(s) and process(es) are provided to produce synthesis gas (syngas) from carbonaceous feedstock and synthesize the syngas into liquid fuel and related byproduct substances. Dissipated heat and byproduct substances are utilized to supply energy to the system(s) and process(es). Utilization of dissipated heat and the byproduct substances as energy sources allows the system(s) and process(es) to be implemented without input from external energy sources. Byproduct substances also are recycled for reconversion to syngas. Syngas is produced in a gasification platform through a multi-phased gasification process comprising pyrolysis of the carbonaceous feedstock, steam reformation (or reaction) of pyrolysis gas, and cleaning of syngas ejected from such steam reformation. The syngas is catalytically converted into a product comprising the liquid fuel and the byproduct substances. Separation of the product enables supply of the liquid fuel and the byproduct substances for enabling, in part, operation of the system(s) and implementation of the process(es).

### PRIORITY CLAIM

This application claims the benefit of U.S. Provisional Patent Application Ser. No. 61/426,303 entitled “PRODUCTION OF LIQUID FUEL OR ELECTRIC POWER FROM SYNTHESIS GAS IN AN INTEGRATED PLATFORM” and filed Dec. 22, 2010, the entirety of which is incorporated by reference.

### TECHNICAL FIELD

The subject disclosure relates to production of bio-fuel from feedstock and, more specifically, yet not exclusively, to production of synthesis gas (syngas) from feedstock and synthesis of the syngas into liquid fuel, electric power, or related byproduct substances.

### BACKGROUND

A convergence of various financial factors, such as increase in fossil fuel costs; market forces (e.g., adherence to sustainable energy consumption paradigms); and geopolitical conditions (instability in oil-rich regions, climate change, etc.) has renewed interest in gasification of organic or carbonaceous materials, often called feedstock, to generate combustible synthesis gas (or syngas) for renewable generation of fuel. Synthesis gas can be utilized to generate electricity with reduced CO₂ emissions compared to electricity derived from fossil fuel. In addition, feedstock utilized for generation of synthesis gas is largely encompassed by post-processed (organically or synthetically) waste; therefore, feedstock is intrinsically sustainable. Amongst various gasification processes commonly employed for generation of synthesis gas is pyrolysis. Such process produces byproducts, such as chars or tars, in addition to production of synthesis gas. In conventional gasification systems, the feedstock is dried and supplied into a stirred, heated kiln. As the feedstock passes through the kiln, combustible synthesis gas is produced and is continuously removed from the kiln. However, production of synthesis gas in conventional gasification systems is generally inefficient, with an energy balance that renders production of fuel or electricity derived thereof commercially non-viable. In addition, conventional processes generally exacerbate commercial viability issues with elevated operational costs associated with process inefficiencies related to manipulation of produced byproducts. In addition, poorly designed management of the byproducts also result in synthesis gas of lesser quality, with ensuing low quality of derived fuels and ensuing limited commercial thereof.

In addition, various conventional technologies are available for conversion of syngas into liquid fuel or byproduct substances. Such technologies typically exploit syngas generated in a gasification stage and convert the syngas into liquid fuel. Yet, such conventional technologies generally perform such conversion inefficiently and demand significant capital expenditure or require feedstock sourcing that the infrastructure exploited by such conventional technologies cannot support. Moreover, many of such conventional technologies exploit infrastructure designed according to design principles that either fails to consider aspects of integration of syngas production and conversion of syngas into liquid fuels or marginally exploit such aspects.

### SUMMARY

The following presents a simplified summary of the subject disclosure in order to provide a basic understanding of some aspects thereof. This summary is not an extensive overview of the various embodiments of the subject disclosure. It is intended to neither identify key or critical elements nor delineate any scope. Its sole purpose is to present some concepts in a simplified form as a prelude to the more detailed description that is presented later.

One or more embodiments of the subject disclosure provide system(s) and process(es) for producing synthesis gas (syngas) from carbonaceous feedstock (biomass, coal, etc.) and synthesize the syngas into liquid fuel and related byproduct substances. The syngas is produced in a gasification stage while the liquid fuel is produced in a liquidification stage in which the syngas is catalytically converted into the liquid fuel. The gasification stage can be a multi-phase gasification process comprising a gasification phase, a steam reformation phase, and a cleaning phase. Likewise, the liquidification stage is a multi-phase liquidification process comprising a syngas conditioning phase, a fuel synthesis phase, and a product separation phase. Byproduct substances include gas-phase hydrocarbons and solid-phase hydrocarbons outside of the liquid-phase hydrocarbon range. Byproduct substances are utilized (directly or indirectly) to supply energy (e.g., thermal, electric) to the system(s) and process(es) and are recycled for reconversion to syngas. Dissipated heat is recovered to provide thermal energy to the system(s) and process(es). Utilization of the byproduct substances and dissipated heat as energy sources render the system(s) and process(es) energy efficient, enabling achievement of high conversion yields (yield of syngas-to-fuel conversion)—in certain scenarios, the system(s) and process(es) achieve conversion yield sufficiently high to render the system(s) and process(es) energetically self-sustained, operating without input from external energy sources. As an example, instead of natural gas, the gas-phase hydrocarbons can be utilized to fire burners. As another example, gas-phase hydrocarbons can be employed for power production. Solid-phase hydrocarbons are recycled to the gasification phase (e.g., a pyrolysis phase) as feedstock material or to the steam reformation phase for re-conversion to syngas. Dissipated heat from the gasification process can be harnessed and recycled into the byproduct substances prior to being introduced into the system(s) and process(es) described herein.

Syngas is produced in a gasification platform that enables the multi-phased gasification process. The gasification platform can enable pyrolysis of the carbonaceous feedstock, steam reformation (or reaction) of pyrolysis gas, and cleaning of syngas produced through such steam reformation. The gasification platform also can enable other thermodynamic processes to decompose and gasify the carbonaceous feedstock material. Clean and dry syngas is collected in the liquidification platform and conditioned for fuel synthesis. The conditioning is implemented in a conditioning phase and includes polishing and compression of collected syngas in addition to blending of the compressed syngas with recycled syngas that is part of byproduct substances. After preparation, conditioned syngas is catalytically converted into a product comprising the liquid fuel and the byproduct substances. The product is separated in the product separation phase; separation of the product enables supply of the liquid fuel and the byproduct substances for enabling, at least in part, operation of the system(s) and implementation of the process(es) described herein.

When compared to conventional technologies for production of liquid fuels from gases, the system(s) and process(es) disclosed herein provide at least the following advantages. (i) Versatility of feedstock utilization. The system(s) can operate, and the process(es) can be implemented, without production disruption even in scenarios in which feedstock properties vary significantly amongst production run. Such versatility of feedstock utilization allows a variety of resource recycle circuits, which reduces or minimizes waste of byproduct substances and dissipated heath, and increases or maximizes overall efficiency of operation. (ii) Positive energy balance. At a time of achieving a production of clean synthesis gas or a time interval thereafter, the multi-phased gasification process disclosed herein can be effected in an energy self-sustained mode, wherein equipment that implement such multi-phased gasification process operates without input from external energy sources. Resources recycled from the fuel production meet energy demands of the system(s) that implement the process for fuel production. The latter is particularly, though not exclusively, important for system(s) (e.g., plants) operating in remote areas where electric power or natural gas is not available to energy the system(s). (iii) Customization of utilization of resource recycle circuits for conditions of fuel market. This flexibility also allows for the process to be adjusted to meet peak market demands by increasing or decreasing the byproduct recycle streams. For example if diesel prices are high then all resource recycle circuits can be adjusted to maximize diesel production, or if electric prices are high, additional gas phase hydrocarbons (e.g., tail gas and syn gas) can be produced for electric generation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example system for production of liquid fuel from synthesis gas in accordance with aspects of the subject disclosure.

FIG. 2 illustrates an example gasification platform that enables generation of synthesis gas in accordance with aspects of the subject disclosure. The example gasification platform can be part of the example system illustrated in FIG. 1.

FIG. 3 illustrates an example liquidification platform that enables conversion of syngas into a hydrocarbon product comprising liquid fuel in accordance with aspects of the subject disclosure. The example liquidification platform can be part of the example system presented in FIG. 1.

FIG. 4 depicts an example embodiment of an assessment platform that can regulate operation of a gasification platform, a liquidification platform, and at least one recycling circuit for byproduct substances in accordance with aspects of the subject disclosure. The assessment platform can be part of example system illustrated in FIG. 1.

FIG. 5 presents an example embodiment of a gasification platform for producing synthesis gas in accordance with aspects described herein.

FIGS. 6A-6B illustrated an example embodiment of a pyrolyzer chamber in accordance with aspects described herein. The illustrated pyrolyzer chamber can be part of the gasification platform presented in FIG. 5.

FIG. 7 illustrates an example embodiment of a liquidification platform for producing liquid fuel in accordance with aspects described herein.

FIG. 8 presents an example method for producing liquid fuel from synthesis gas in an integrated platform according to aspects described herein.

FIG. 9 illustrates an example method for producing synthesis gas in accordance with aspects described herein.

FIG. 10 illustrates an example method for producing liquid fuel and related byproduct substance(s) according to aspects described herein.

FIGS. 11-12 present example methods for integrating production of synthesis gas and synthesis of liquid fuels according to aspects described herein.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the various embodiments of the subject disclosure may be practiced without these specific details. In other instances, well-known structures and devices are shown in block diagram form in order to facilitate describing the subject disclosure.

As employed in this specification and annexed drawings, the terms “component,” “unit”, “system,” “structure,” “platform,” “interface,” and the like are intended to include a computer-related entity or an entity related to an operational apparatus with one or more specific functionalities, wherein the entity can be either hardware, a combination of hardware and software, software, or software in execution. One or more of such entities are also referred to as “functional elements.” As an example, a component may be, but is not limited to being a process running on a processor, a processor, an object, an executable, a thread of execution, a program, and/or a computer. As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. An illustration of such a component can be a water pump. In addition or in the alternative, a component can provide specific functionality based on physical structure or specific arrangement of hardware elements; an illustration of such a component can be a filter or a fluid tank. As yet another example, a component can be an apparatus that provides specific functionality through electronic components without mechanical parts, the electronic components can include a processor therein to execute software or firmware that provides at least in part the functionality of the electronic components. An illustration of such apparatus can be control circuitry, such as a programmable logic controller. The foregoing example and related illustrations are but a few examples and are not intended to limiting. Moreover, while such illustrations are conveyed for a component, the examples also apply to a system, a structure, a platform, an interface, and the like.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of synthesis gas collection structures includes one or more synthesis gas collection structures; a set of devices includes one or more devices; a set of regulators includes one or more regulators; etc.

Various aspects or features will be presented in terms of systems that may include a number of devices, components, modules, and the like. It is to be understood and appreciated that the various systems may include additional devices, components, modules, etc., or may not include all of the devices, components, modules etc. discussed in connection with the figures. A combination of these approaches also can be used.

As described in greater detail below, the subject disclosure provides system(s) and method(s) for produce synthesis gas (syngas) from carbonaceous feedstock and synthesize the syngas into liquid fuel and related byproduct substances. The system(s) and method(s) disclosed herein enable a unique integration of a non-combustive gasification process and platform with a matched gas-to-liquid process and liquidification platform that allows highly efficient conversion of carbonaceous feedstock material that can be economically sourced into clean liquid fuel. In an aspect, the unique integration and related design principles is founded at least on (i) reutilizing and recycling byproducts substances produced in the gasification process and the gas-to-liquid process in order to attain desired or satisfactory (e.g., maximal) liquid fuel production, (ii) mitigating or avoiding waste-generating processes, and (iii) sharing thermal energy (e.g., heat flow(s)) between the gasification platform and the liquidification platform in order to attain desired or satisfactory (e.g., optimal) efficiency.

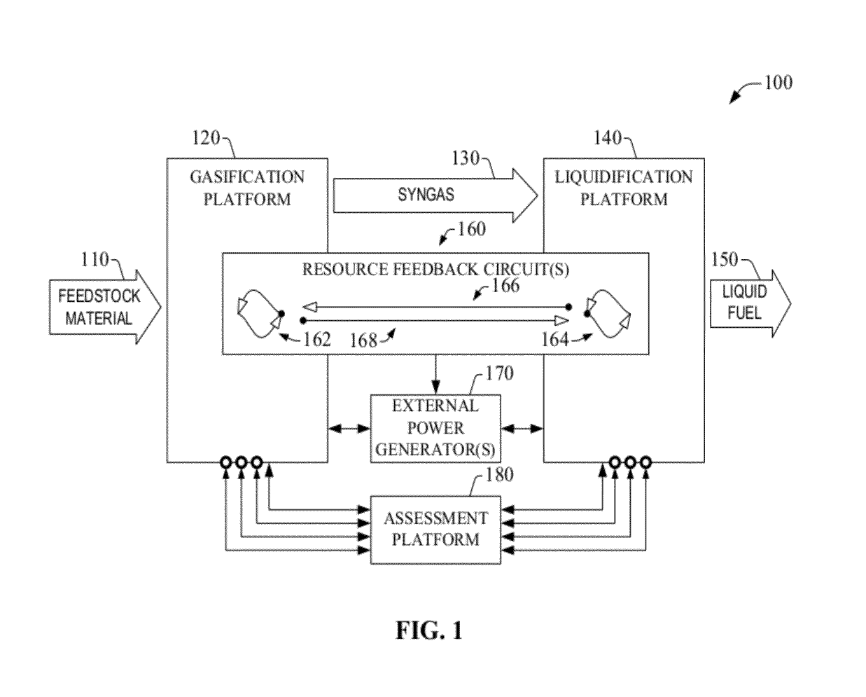

In connection with the drawings, FIG. 1 is a block diagram that illustrates an example system 100 for production of liquid fuel from synthesis gas in accordance with aspects of the subject disclosure. The synthesis gas is produced in a gasification stage while the liquid fuel is produced in a liquidification stage in which syngas produced in the gasification stage is catalytically converted into the liquid fuel. Example system 100 includes a gasification platform 120 that enables the gasification stage, which yields clean syngas 130. In addition, example system 100 includes a liquidification platform 140 that consumes the clean syngas 130 and enables the liquidification stage, which yields liquid fuel 150. Gasification platform 110 and liquidification platform 140 are integrated, at least in part, through a set of one or more resource feedback circuit(s) 160 that can enable recycling syngas or at least one byproduct substance produced in the gasification stage or in the liquidification stage. In addition, at least one resource feedback circuit can enable reutilization of process heat generated in various phases of the gasification stage or the liquidification stage.

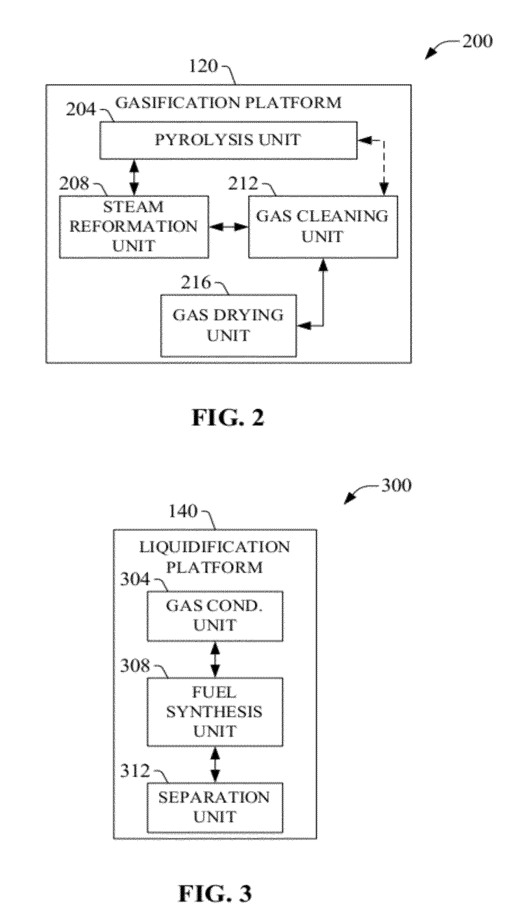

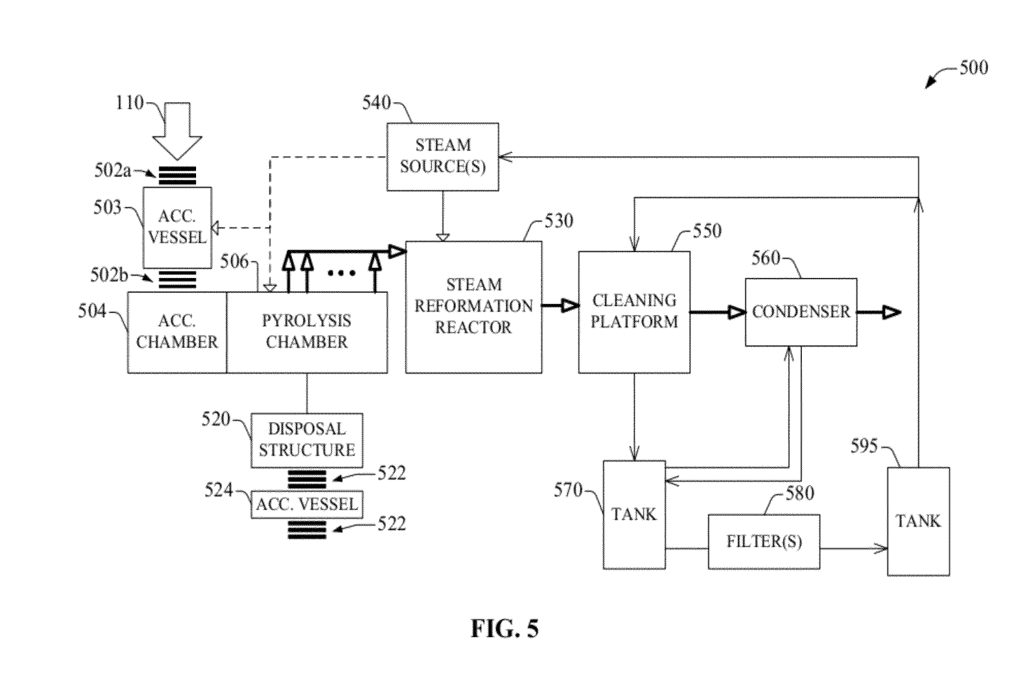

Gasification platform 120 enables a decomposition and gasification stage that is a multi-phase gasification process comprising a gasification phase, a steam reformation phase, and a cleaning phase. The gasification phase is a non-combustion gasification phase in which feedstock material 110 is gasified. Various types of feedstock material 110 can be employed in the gasification phase, such as biomass (wood, rice, corn, or sugar cane harvest waste, etc.), municipal waste (moist or dry), farm compost, coal, petroleum coke, and the like. The gasification phase yields gas and byproduct solids. In an embodiment, the gasification phase is a pyrolysis phase that yields pyrolysis gas which includes synthesis gas (syngas) and other gases comprising heavier molecules. In addition, in such embodiment, the byproduct solids resulting from gasification can include incompletely pyrolyzed feedstock material, such as char, bio-char, or the like. In certain embodiments, the gasification phase can incorporate steam from an external source (not shown) to react gas that results from gasification and produce a larger concentration of synthesis gas (syngas) or a syngas with better chemical composition. In certain embodiments, e.g., example embodiment 200 presented in FIG. 2, gasification platform 120 includes a pyrolysis unit 204 that enables the gasification phase. The pyrolysis unit 204 includes structure that enables injection of feedstock material 110 into at least one gasification chamber (e.g., a pyrolysis chamber). In an aspect, the structure allows regulation of oxygen and moisture content in the feedstock material 110 via atmosphere purging and steam injection. In addition, pyrolysis unit 204 includes a disposal structure (see, e.g., FIG. 4) that maintains at least pressure condition and allows byproduct solids to be discarded or reutilized.

The gasification phase is implemented at predetermined pressure (P_{P}) and temperature (T_{P}). In addition, decomposition and gasification of the feedstock material 110 is effected for a predetermined period Δτ_{P}. Specific values of pressure P_{P}, temperature T_{P}, and Δτ_{P} can be determined through simulation or experimentation. In one or more embodiments, P_{P} ranges from about 25 psi to 100 psi—lower or higher values also can be employed; and T_{P} ranges from nearly 1000° F. to nearly 1750° F. In addition, 10 min≦Δτ_{P}≦36 min, where “min” is the abbreviation of the term minutes; in an embodiment, Δτ_{P} is equal to about 36 min and in another embodiment Δτ_{P} is equal to about 10 min. Values of P_{P} elevated with respect to atmospheric pressure allow high efficiency, e.g., high gas yield, of the gasification phase.

The gas produced in the gasification phase includes syngas and, in certain scenarios, the gas is substantially syngas. Such syngas generally has an H₂/CO molar ratio that is non-ideal for fuel production. Accordingly, at least a portion of the gas produced in the gasification phase is streamed to the steam reformation phase in which the syngas in the gas is reacted with steam (e.g., superheated steam) and thus reformed into reacted syngas, which his raw syngas with H₂/CO molar ratios more suitable for liquid fuel production. In an aspect, the steam reformation phase yields consistent raw syngas, wherein the consistent raw syngas can be saturated syngas—e.g., syngas with nearly the highest H₂/CO molar ratio. Reaction of produced syngas with steam is sustained for a period Δτ_{R}, which in certain embodiments can satisfy Δτ_{R}≦10 seconds (s), or Δτ_{R} equal to about 10 s; e.g., 3 s≦Δτ_{R}≦5 s. The product of the steam reformation phase is reacted syngas, which can be supplied to the cleaning phase to yield clean syngas 130. In example embodiment 200, gasification platform 120 includes a steam reformation unit 208 that enables the steam reformation phase.

The clean syngas 130 generally is saturated and can be generated through removal of particulate matter (pm), tars, and other contaminants (sulfur-based compounds, soluble acid gas(es), etc.) from the reacted syngas produced in the steam reformation phase. Structure that enables the cleaning phase can include a set of cyclones through which raw gas is circulated. In addition, the cleaning phase can include liquid-based refrigeration of the reacted syngas 150, which is saturated dirty syngas at elevated temperature, e.g., 1000° F. or about 1000° F. In certain embodiments, cleaning phase does not include a cooling stage—for example, reacted syngas is not circulated through an entrained heat-flow exchanger—and thus temperature of the reacted syngas can range from about 1700° F. to about 1750° F. In an aspect, the temperature of the reacted syngas is reduced to about saturation temperature (e.g., 237° F. under certain conditions) through, for example, ambient-temperature liquid coolant (e.g., water) that removes the particulate matter, the tars, and other contaminants from the reacted syngas. In additional or alternative aspects, the temperature of the reacted syngas can be reduced to temperatures below the saturation temperature (for example, 237° F. under certain conditions) or to temperatures above the saturation temperature, but that are substantially lower than the temperature at which the reacted syngas exits the steam reformation phase. It is noted that in one or more embodiments, the temperature of the reacted syngas is lower than about 237° F., while in alternative or additional embodiments, the temperature of the reacted syngas is higher than about 237° F. In example embodiment 200, gasification platform 120 includes a gas cleaning unit 212 that enables the gas cleaning phase. In such example embodiment, gasification platform 120 also includes a gas drying unit 216 for cooling the syngas and removing moisture therein.

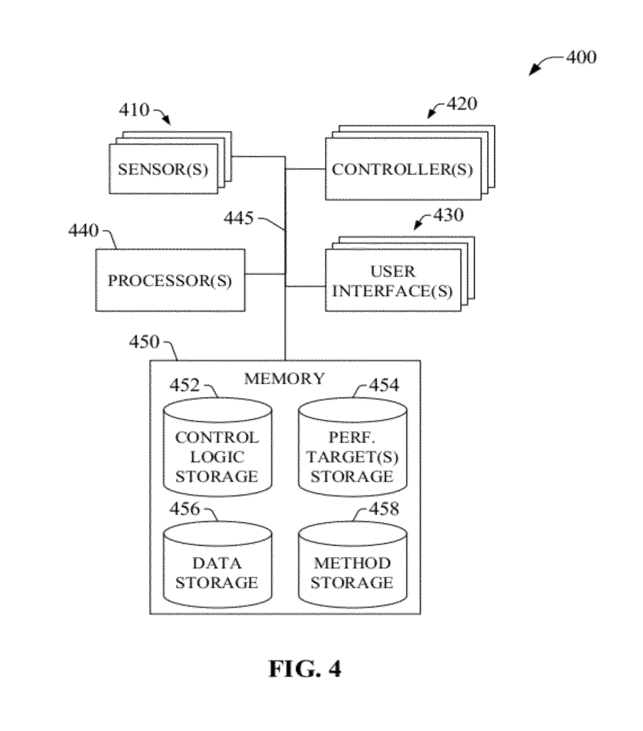

Liquidification platform 140 enables a liquidification stage that is a multi-phase liquidification process comprising a gas conditioning phase, a fuel synthesis phase, and a product separation phase. Clean syngas 130 or a portion thereof is collected in the liquidification platform 140 and conditioned in the gas conditioning phase for fuel synthesis. The gas conditioning phase includes polishing and compression of at least a portion of the clean syngas 130, and blending of recycled syngas that is part of byproduct substances with syngas resulting from such compression. Conditioned syngas (e.g., syngas that is blended and compressed) is catalytically converted into a hydrocarbon product in a fuel synthesis phase, wherein the hydrocarbon comprises the liquid fuel 150 and byproduct substances. The hydrocarbon product is separated in the product separation phase; separation of the hydrocarbon product enables supply of the liquid fuel 150 and the byproduct substances for enabling, at least in part, operation of liquidification platform 140 and gasification platform 120. In certain embodiments, e.g., example embodiment 300 presented in FIG. 3, liquidification platform 140 includes a gas conditioning (cond.) unit 304 that enables the conditioning phase, a fuel synthesis unit 308 that enables catalytic conversion of the conditioned syngas into the hydrocarbon product, and a separation unit 312 that enables separation of the hydrocarbon product into solid-phase hydrocarbons, liquid-phase hydrocarbons, gas-phase hydrocarbons, and water. The water that results from such separation is referred to as waxy water.

As indicated supra, in example system 100, a set of one or more resource feedback circuit(s) 160 can enable recycling syngas or at least one byproduct substance produced in the gasification stage or in the liquidification stage. The set of one or more resource feedback circuit(s) 160 also enable recuperating dissipated heat or water. Moreover, at least one resource feedback circuit can enable reutilization of process heat, or dissipated heat, generated in various phases of the gasification stage or the liquidification stage. The set of one or more resource feedback circuit(s) 160 can be divided into two categories, each category including two sub-sets, with each sub-set including at least one resource feedback circuit: (I) A first category is intra-feedback loops. A first sub-set of resource feedback circuits 162 in such category includes at least one resource feedback circuit deployed within gasification platform 120. The at least one resource feedback circuit can direct condensate water from the cleaning phase to the steam reformation phase; for example, in an embodiment, the condensate water can originate in the gas cleaning unit 212 and it can be supplied to the steam reformation unit 208. Reutilization of water increases efficiency of the multi-phased gasification process and equipment (e.g., example gasification system 200) that carry out such process. In addition, reutilization of water can enable, in part, deployment of such equipment (e.g., example gasification system 200) in remote locations with limited access to water or where water is obtained through costly process(es) such as desalinization. In addition or in the alternative, the at least one resource feedback circuit can be a water return loop that supplies water from a first structure that enables the cleaning phase to a second structure in the cleaning phase. Moreover, or as another alternative, the at least one resource feedback circuit can direct steam generated in the steam reformation phase to the gasification phase, wherein the steam can be injected into a feedback injection phase or into a gasification chamber in which decomposition and gasification of feedstock material 110 occurs; for example, in an embodiment, the steam can flow from steam reformation unit 208 to pyrolysis unit 204. Furthermore, or as yet another alternative, the at least one resource feedback circuit can transport dissipated heat, through combustion air, for example, from the gasification phase to the steam reformation phase for production of steam; as an example, in an embodiment, process heat released in pyrolysis unit 204 can be recovered and supplied to the steam reformation unit 208. A second sub-set of resource feedback circuits 164 in the intra-feedback loops category includes at least one resource feedback circuit deployed within liquidification platform 140. The at least one resource feedback circuit can supply unreacted syngas from the product separation phase to the gas conditioning phase; for example, in an embodiment, separation unit 312 can supply the unreacted syngas to gas conditioning unit 304.

(II) A second category is inter-feedback loops. Inter-feedback loops are distributed amongst gasification platform 120 and liquidification platform 140. A first sub-set of resource feedback circuits 166 in such category includes at least one resource feedback circuit that transports at least one byproduct substance from gasification platform 120 to liquidification platform 140. The at least one resource feedback circuit can supply steam from the steam reformation phase enabled by gasification platform 120 to a fuel synthesis phase enabled by liquidification platform 140. A second sub-set of resource feedback circuits 168 in such category includes at least one resource feedback circuit that transports at least one byproduct substance from liquidification platform 140 to gasification platform 120. The at least one resource feedback circuit can supply solid-phase hydrocarbons produced in liquidification platform 140 to a feedstock material input phase effected in gasification platform 120; in an aspect, the solid-phase hydrocarbons (e.g., Fischer-Tropsch waxes) can be employed to adjust the feedstock material moisture content to a desired level. In addition or in the alternative, the at least one resource feedback circuit can supply gas-phase hydrocarbons, e.g., tailgas, ejected from liquidification platform 140 as fuel for burners that heat structures in either the gasification phase or the steam reformation phase; such tailgas can have substantially the same British Thermal Unit (BTU) per standard cubic foot as that of product syngas generated in the gasification platform 140. The at least one resource feedback circuit also can recycle gas-phase hydrocarbons ejected from liquidification platform 140, e.g., tailgas, into the steam reformation phase for reformation into raw syngas. Furthermore, or as yet another alternative, the at least one resource feedback circuit can supply an aqueous portion of liquid-phase hydrocarbons produced in the liquidification platform 140 to the steam reformation phase enabled by the gasification platform 120; as an example, in an embodiment, the aqueous portion of liquid-phase hydrocarbons can be supplied from separation unit 312 to structure for steam production within the steam reformation unit 208.

In example system 100, at least one resource feedback circuit in the set of one or more resource feedback circuit(s) 160 can provide tailgas or syngas, or both, to external power generator(s) 170 in order to produce electricity. The electricity can be exploited to energize equipment or one or more structures (e.g., motor drives that rotate a set of drums in pyrolysis chamber 406) within gasification platform 120 or liquidification platform 140.

Additionally, at a time of achieving production of clean syngas 130 or after a time interval thereafter, gasification of feedstock 110 and liquidification of clean syngas 130 disclosed herein can be effected in an energy self-sustained mode. Utilization of produced clean syngas to fuel or to produce electricity and energize the various structures that enable the gasification stage or the liquidification stage leads to emissions that are low, similar to emissions that result when clean natural gas is utilized, for example. Clean syngas produced in the gasification stage described herein is carbon neutral, wherein carbon-based emissions are avoided. In addition, utilization of produced clean syngas also allows for consistent gas (e.g., gas with consistent chemical composition) to be provided to one or more structures that enable the gasification stage or the liquidification stage. In contrast, it should be appreciated that with various conventional gasification processes, the combustion of the feedstock (e.g., feedstock material 110) provides process heat (e.g., process of combustion (POC) heat) that produces large amounts of contaminants and introduces process variation related to feedstock type, composition size, and moisture.

In the energy self-sustained mode, production of clean syngas is effected at a predetermined rate with a specific product mix standard, e.g., a specific quality (H₂/CO ratio, concentration of impurities, etc.) of the clean syngas, and at least a portion of the clean syngas 170 fuels or energizes equipment that enables at least one of the gasification phase, the steam reformation phase, or the cleaning phase. Such energy self-sustained mode of implementation of the multi-phased gasification process that embodies the gasification stage described herein is at least another advantage of the subject disclosure; energy self-sustained mode of implementation is generally not accomplished in conventional gasification systems.

Example system 100 also includes an assessment platform 180, which can regulate various operational aspects of liquid fuel production and manage resources associated therewith in accordance with aspects described herein. To implement such regulation, assessment platform 180 can monitor a set of operational conditions of one or more of gasification platform 120 or liquidification platform 140. The set of operational conditions can include (A) input condition(s), (B) processing condition(s), and (C) output condition(s). (A) An input condition characterizes at least one value of at least one variable related to input entities (e.g., feedstock material (e.g., 110), steam, a volume of waxy water . . . ) injected into a process (e.g., example method 700) for production of liquid fuel or electric power described herein; or equipment operating in a mode capable to manipulate the input entities according to such process. (B) A processing condition characterizes at least one value of at least one variable related to entities that enable the process for production of liquid fuel or electric power described herein. As an example, one of such entities can be a gasification unit (e.g., pyrolysis unit 204) and the at least one variable can be temperature (e.g., T_{P}) and pressure (e.g., P_{P}), which establish, at least in part, a gasification condition for feedstock material gasified in the gasification unit. As another example, one of such entities can be a steam reformation unit (e.g., 208) and the at least one variable can be temperature of steam injected into the steam reformation unit (e.g., 208). (C) An output condition characterizes at least one value of at least one variable related to output entities, such as a hydrocarbon product comprising solid-phase hydrocarbons, liquid-phase hydrocarbons (e.g., 680), and gas-phase hydrocarbons (e.g., 670).

To monitor at least one operational condition, the assessment platform 180 can collect data related to operational conditions of example system 100. To collect such data, assessment platform 180 can perform measurements or cause at least one sensor in a set of sensors to perform measurements; output of such measurements supplies the data. In an embodiment, e.g., example embodiment 400 illustrated in FIG. 4, the data can be retained in data storage 456 within a memory 450 that is part of the assessment platform 180 or is functionally coupled thereto. Assessment platform 180 can implement (e.g., execute) control logic that establishes one or more features of data collection. As an example, the control logic can establish a mode of measurement—e.g., real-time data collection or nearly real-time data collection, scheduled data collection, interactive data collection, or the like. The control logic also includes a set of computer-executable code instructions that, when executed by a processor (e.g., processor(s) 440) that is part of assessment platform 180, cause the assessment platform 180 to direct the at least one sensor in the set of sensors to collect data according at least in part to the measurement mode. In certain embodiments, such as example embodiment 400, the control logic can be retained in control logic storage 452, a group of one or more controller(s) 420 can direct the at least one sensor in the set of sensors to collect data in accordance with the measurement mode. The set of sensors includes a first group of sensors distributed in gasification platform 120 and a second group of sensors distributed in the liquidification platform 140; such groups of sensors are pictorially depicted with groups of three open circles connected to assessment platform 180. The set of sensors also can include sensors (not depicted) distributed within the resource feedback circuit(s) 160. In certain embodiments, example embodiment 400 illustrated in FIG. 4, the set of sensors can be embodied in sensor(s) 410; the set of sensors can include pressure gauges, flow gauges; thermocouples or other temperature monitoring devices; spectroscopic sensors, such as mass spectrometers, optical spectrometers, photo-detectors; or the like.

In an aspect, assessment platform 180 can measure moisture content of at least a portion of feedstock material 110 injected into the gasification platform 120. Measurement of such moisture content can be performed in accordance with a predetermined measurement mode. In another aspect, assessment platform 180 can measure a volume of an aqueous portion (e.g., a waxy water portion) of liquid-phase hydrocarbons (e.g., 680) produced in the liquidification platform 140. Measurement of such volume can be performed in accordance with a predetermined measurement mode. In yet another aspect, assessment platform 180 can measure volume and composition of tailgas, or gas-phase hydrocarbons (e.g., 670) produced in liquidification platform 140. In still another aspect, assessment platform 180 can measure volume and composition of product syngas (e.g., syngas 130). Measurements of volume and composition of tailgas or syngas can be performed in accordance with a predetermined measurement mode.

Based on the data related to operational conditions of example system 100, assessment platform 180 can regulate the various operational aspects of liquid fuel production and manage the resources associated therewith as described herein. In an embodiment, e.g., example embodiment 400, such regulation can be enabled or implemented by at least one controller in the group of one or more controller(s) 420. In an aspect, the control logic defines, at least in part, various responses that enable assessment platform 180 to regulate such operational conditions in response to such data. In another aspect, the control logic can dictate, at least in part, intended operational performance, such as production of syngas (e.g., syngas 130) and features of produced syngas, such as syngas composition; production of waxy water; utilization of feedstock material; utilization of steam; utilization of tailgas; and so forth. In an embodiment, e.g., example embodiment 400, various parameters representative of performance thresholds can enable at least in part evaluation of operational performance; the various parameters can be retained in performance (perf.) target(s) storage 454. Assessment component 180 can adjust at least one control parameter (temperature, pressure, flow of stem, rate of feedstock loading, amount of feedstock loading, etc.) that regulates the various operational conditions of at least one of the gasification platform or the liquidification platform in order to attain an intended operational performance.

Assessment platform 180 can determine values of the set of parameters {P_{P}, T_{P}; Δτ_{P}} autonomously in order to attain specific output performance, including syngas quality, syngas yield; specific loading rate(s) of feedstock material 110; particular operational costs; or the like. In addition, after establishing specific intended values of P_{P}, T_{P}, and Δτ_{P}, assessment platform 180 can control at least one operational condition (e.g., input condition(s), processing condition(s), output condition(s), or any combination thereof) to achieve or maintain the intended values. Values of the set of parameters {P_{P}, T_{P}; Δτ_{P}} can be based at least on one or more of (i) intended operational condition(s), such as amount of input feedstock material 110, type of feedstock material 110, moisture level of feedstock material 110, particle size of feedstock material 110, or likely or expected types of byproduct produced through gasification of feedstock material 110, intended synthesis gas yield; (ii) budgetary or other financial considerations; (iii) delivery and installation costs of equipment to perform the primary gasification phase 120; or the like.

Assessment platform 180 can analyze disposable solid matter originated through gasification of the feedstock material 110. Disparate density of various components of disposable solid matter can result in separation of more dense material, which can be more likely to be reformed into syngas in an additional cycle of gasification than less dense material such as ash. To analyze the disposable solid matter, assessment platform 180 can collect spectroscopic data or thermochemical data in situ; one or more sensors of the first group of sensors distributed in the gasification platform 120 can collect the spectroscopic data o the thermochemical data. Such data in conjunction with a set of criteria (e.g., predetermined composition of probed material) can establish if additional gasification is warranted. The set of criteria can be stored in a memory or memory element (database, register(s), file(s), etc.) within assessment platform 180 or functional coupled thereto.

In addition or in the alternative, assessment platform 180 can analyze physical properties or chemical properties of product syngas (e.g., clean syngas 130). Data collected as part of such analysis can be contrasted with a set of quality criteria to establish if quality of syngas warrants bypassing the steam reformation phase (enabled by steam reformation unit 208 in pyrolysis unit 204, as described supra). In certain embodiments, assessment platform 180 also can analyze a sample of feedstock material 110 and determine that carbon content in the feedstock material is sufficiently low so as not to justify steam reaction, and thus gas produced in the gasification phase can be supplied directly to the cleaning phase. In example embodiment 200, such scenario is illustrated with a dashed arrow representing optional direct injection of pyrolysis gas from pyrolysis unit 204 into gas cleaning unit 212. In the alternative or in addition, assessment platform 180, via, for example, at least one sensor, also can measure moisture content of feedstock material 110. Based on data collected as part of measurements of moisture content of feedstock material 110, assessment platform 110 can adjust volume, or amount, of steam injected into an accumulation vessel (e.g., 403) to regulate moisture content of feedstock material collected in the accumulation vessel.

Moreover, in certain embodiments, assessment platform 180 can adjust a temperature profile, e.g., temperature setpoints at various instants, in a gasification unit (e.g., pyrolysis unit 204) in the gasification platform 120 to generate a satisfactory (optimal or nearly-optimal, predetermined, etc.) utilization of feedstock material 110 and an aqueous portion of liquid-phase hydrocarbons (e.g., 680) produced in example system 100. Furthermore, in an embodiment, assessment platform 180 can adjust (e.g., increase, decrease, preserve, etc.) consumption of a feedback stream of a byproduct substance in the gasification platform 120 in order to achieve an intended performance target. In a scenario, assessment platform 180 can reduce or terminate consumption of an external source of energy (e.g., natural gas) and increase consumption of tailgas—for example, a volume of natural gas, a volume of syngas, and a volume of tailgas employed to ignite burner that provide heat to gasification platform 120 can be adjusted based on operational condition(s) of liquidification platform 140. Such reduction or termination in combination with such increase represents an adjustment of utilization of resources available to the example system 100. In another scenario, assessment platform 180 can reduce or terminate consumption of a volume of externally supplied water and increase a volume of waxy water (e.g., aqueous portion 682).

In various scenarios, the various analyses, measurements, and controls effected by assessment platform 180 can enable, at least in part, operation of example system 100 with limited resources, particularly, though not exclusively, in operational locations in which feedstock is costly, such as in remote locations, or during unusual operational conditions, e.g., stored feedstock is unusable because of poor storage conditions. The benefit of achieving an energy self-sustained mode of operation generally outweighs the cost and related complexity of conducting the various analyses, measurements, and controls.

In one or more embodiments, assessment platform 180 can exploit artificial intelligence (AI) methods to generate the foregoing assessment(s) without human intervention as described supra. Such AI method can exploit intelligence (e.g., information) related to operational condition(s) of example system 100; in certain implementations, the intelligence can be generated through inference, e.g., reasoning and conclusion synthesis based upon a set of metrics, arguments, or known outcomes in controlled scenarios, or training sets of data. Artificial intelligence methods or techniques referred to herein typically apply advanced mathematical algorithms—e.g., decision trees, neural networks, regression analysis, principal component analysis (PCA) for feature and pattern extraction, cluster analysis, genetic algorithm, or reinforced learning—to a data set.

Such AI methodologies (AI methods, AI techniques, etc.) can be retained in method storage 458 and can include, for example, Hidden Markov Models (HMMs) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers such as methods referred to as “neural network” methodologies, fuzzy logic methodologies can also be employed. Moreover, game theoretic models and other approaches that perform data fusion, etc., can be exploited.

As illustrate in example embodiment 400, processor(s) 440 can be configured to enable or can enable, at least in part, the described functionality of assessment platform 180, or components therein. In an aspect, to enable such functionality, the processor(s) 440 can exploit a bus that can be part of the assessment platform 180 to exchange data or any other information amongst components therein and memory 450 or elements therein (e.g., method storage 458 or an algorithm storage (not shown), data storage 456, control logic storage 452, etc.). The bus 445 can be embodied in at least one of a memory bus, a system bus, an address bus, a message bus, or any other conduit, protocol, or mechanism for data or information exchange among components that execute a process or are part of execution of a process. The exchanged information can include at least one of code instructions, code structure(s), data structures, or the like.

It is noted that gasification platform 120, liquidification platform 140, and resource feedback circuit(s) 160 described herein include equipment, components, or other structure for automated control of the various portions of gasification stage, liquidification stage, and related recovery of resources (heat, byproduct substances, etc.) disclosed herein. The equipment, components, or other structure for automated control can be deployed and configured (e.g., programmed) in accordance with various aspects described herein and via conventional and novel control paradigms, mechanisms, or programming.

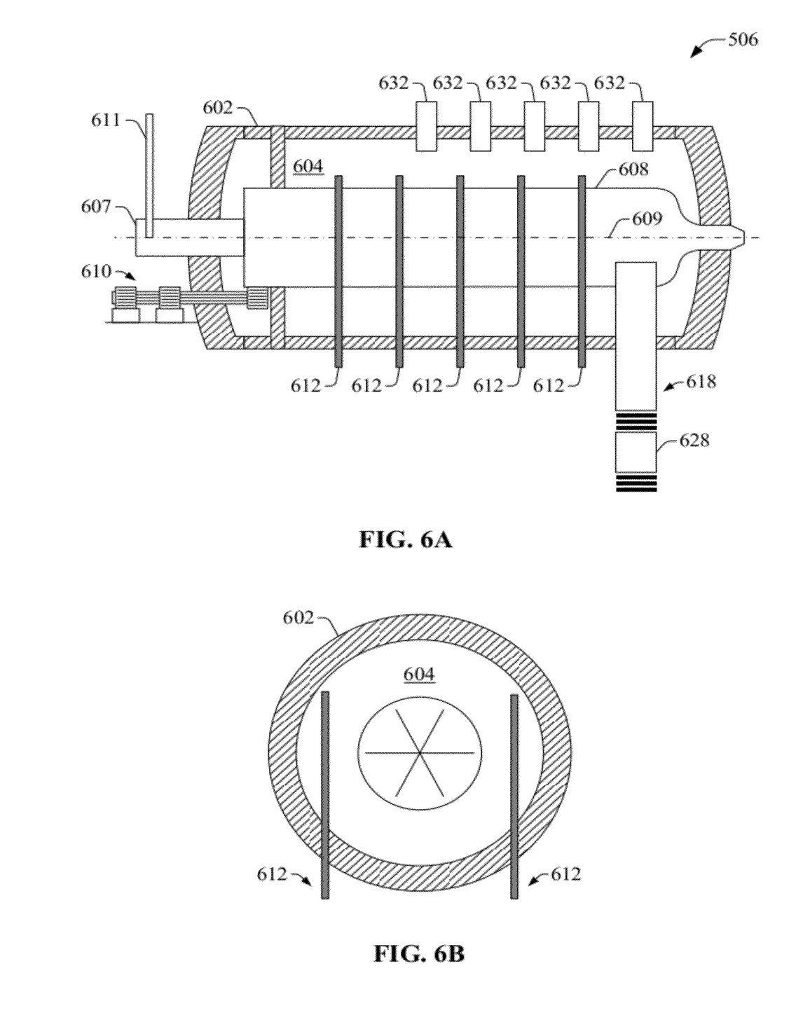

FIG. 5 is a block diagram of an example embodiment 500 of a gasification platform 120 that enables implementation of the gasification stage described hereinbefore in connection with FIG. 1. An amount (e.g., weight or volume) of feedstock material 110 is supplied through a set of air-lock valves 502a, an accumulation (acc.) vessel 503, and an accumulation chamber 504 into a pyrolysis chamber 506, which effects a primary gasification phase (e.g., 120) as described supra. While illustrated with a pyrolysis chamber, in one or more embodiments, any or most any suitable gasification chamber can be employed in example gasification system 500, wherein a suitable gasification chamber has the physical properties that enable a gasification phase (e.g., primary gasification phase 120) as described herein. In addition, in certain embodiments, a plurality of two or more pyrolysis chambers or gasification chambers of other kind can be deployed (e.g., installed, tested, and accepted) in example system 500. The amount of feedstock material 110 can be metered prior to injection into the accumulation vessel 503 through the set of air-lock valves 502a (such set represented with thick line segments in FIG. 5); the feedstock material 110 can be injected at a feed rate that ranges from about 5 to about 500 dtpd (dry tons per day). The injection of the feedstock material 110 can be accomplished in part through a conveyor line (not shown) that delivers the feedstock material to a hopper (not shown) functionally coupled to the set of air-lock valves 502a. Feedstock material 110 can collect continually in the hopper (not shown).

To inject an amount of feedstock material 110 into accumulation vessel 503, at least one air-lock valve in the set of air-lock valves 502a is opened for a period of time suitable to inject the amount of feedstock material 110, while each air-lock valve in a set of air-lock valves 502b at the opposing end of accumulation vessel 503 remains closed. After injection of the amount of feedstock material 110 is complete, the at least one air-lock valve in the set of air-lock valves 502a is closed and the accumulation vessel 503 is pressurized to an operating pressure substantially the same as the pressure of gasification phase; e.g., pressure P_{P} in the range from about 25 psi to about 100 psi. It should be appreciated that the sets of air-lock valves 502a and 502b and the accumulation vessel 503 enable supply of the amount of feedstock material 110 at any or most any predetermined pressure higher than atmospheric pressure. After pressurization of accumulation vessel 503, at least one air-lock valve in the set of air-lock valves 502b is opened, which allows at least a portion of the amount of feedstock material 110 to be supplied to accumulation chamber 504 at the operating pressure (e.g., a pressure in the range from about 25 psi to nearly 100 psi). In addition, accumulation chamber 504 includes a structure, such as an auger or a plunger, that enables ejecting the amount of feedstock material 110 collected in the accumulation chamber 504 to the pyrolysis chamber 506. In an embodiment, the plunger can be embodied in a pneumatic cylinder functionally coupled (e.g., through a rigid bar and suitable attachment(s)) to a plate that can push at least a portion of the amount of feedstock material 110 into the pyrolysis chamber 506. Accumulation chamber 504 also includes at least one control valve (not shown) that holds positive pressure (e.g., a pressure from about 25 psi to about 100 psi) in example gasification system 500.

In an aspect of the subject disclosure, the two sets of air-lock valves 502a and 502b, and the accumulation vessel 503 allow air removal from collected feedstock material 110. The air removal mitigates (e.g., avoids) injection of air into the pyrolysis chamber 506 and can improve quality (H₂/CO molar ratio, concentration of impurities, etc.) of synthesis gas produced as part of generation of gas (e.g., pyrolysis gas) through the primary gasification phase (e.g., 120). In an aspect, as part of pressurization of accumulation vessel 503, operating pressure of example gasification system 500 flushes, or purges, air contained in the feedstock material 110 collected in the accumulation vessel 503. As indicated supra, the operating pressure can range from nearly 25 psi to nearly 100 psi.

Injection of the feedstock material 110 can be accomplished in batch mode. The set of air-lock valves 502b (such set represented with thick line segments in FIG. 5) functionally connected to accumulation chamber 504 can enable providing the amount of feedstock material 110 in such batch mode, with a predetermined batch cycle period or in continuous mode; a batch cycle period can range from about 1 minute to about 10 minutes. The amount of feedstock material 110 that is loaded in accumulation chamber 504 is dictated at least in part by a feed rate, e.g., a rate at which feedstock material 110 is supplied; it should be appreciated that feedstock material 110 is loaded when at least one air-lock valve in the set of air-lock valves 502b is open. In batch mode, loading of feedstock material 110 for a batch cycle is initiated through depressurization of accumulation vessel 503 to recover normal atmospheric condition from operating pressure (e.g., nearly 25 psi to nearly 100 psi) of example gasification system 500 in order to enable an amount of feedstock material to be collected in the accumulation vessel 503 from the hopper (not shown) and supplied to accumulation chamber 504, as described supra. It should be appreciated that depressurization of accumulation vessel 503 occurs with each air-lock valve in the set of air-lock valves 502a and each air-lock valve in the set of air-lock valves 502b is closed. In an embodiment, process gas relieved as part of the depressurization circulates through a baghouse (not shown), which enables removal of any or most any feedstock particulate matter that is present in the relieved process gas. In an aspect, relieved process gas cleansed through the baghouse (not shown) is supplied to a closed circuit of combustion air to be combusted as part of the multi-phase gasification process described herein. At least one advantage of the closed circuit for combustion air is that process gas is not released to the atmosphere with the ensuing environmental adequacy. Thus administrative procedures such as procurement of permit(s) for deployment of gasification systems described herein (e.g., example system 500) can be simplified.

In contrast to conventional gasification systems, in view of a steam reformation stage that is part of non-combustion gasification described herein, the feedstock material 110 injected into example gasification system 500 can contain moisture and thus it need not be dried prior to injection into the pyrolysis chamber 506. In particular, though not exclusively, in one or more embodiments, a volume of steam can be supplied to pyrolysis chamber 506. Injection of the volume of steam is optional—as represented by a dashed flat, short arrow that reaches the pyrolysis chamber 506—and allows control of the composition of produced synthesis gas during the various gasification phases conducted in example gasification system 500. In addition or in the alternative, steam can be injected in the accumulation vessel 503; injection of such steam also is optional. Injection of steam allows for production of synthesis gas with specific, predetermined chemical composition (e.g., ratio of H₂ to CO); based at least on moisture of the feedstock material 110, an amount (e.g., a flow or a volume) of steam is regulated to achieve a specific, desired ratio of steam to carbon for a desired syngas composition. Moreover, in additional or alternative embodiments, injection of feedstock material 110 into pyrolysis chamber 506 can include addition of water into the feedstock material; water can be injected in a specific water-to-solid ratio ρ (a real number). As an example, ρ can range from about 1 to about 1.5.

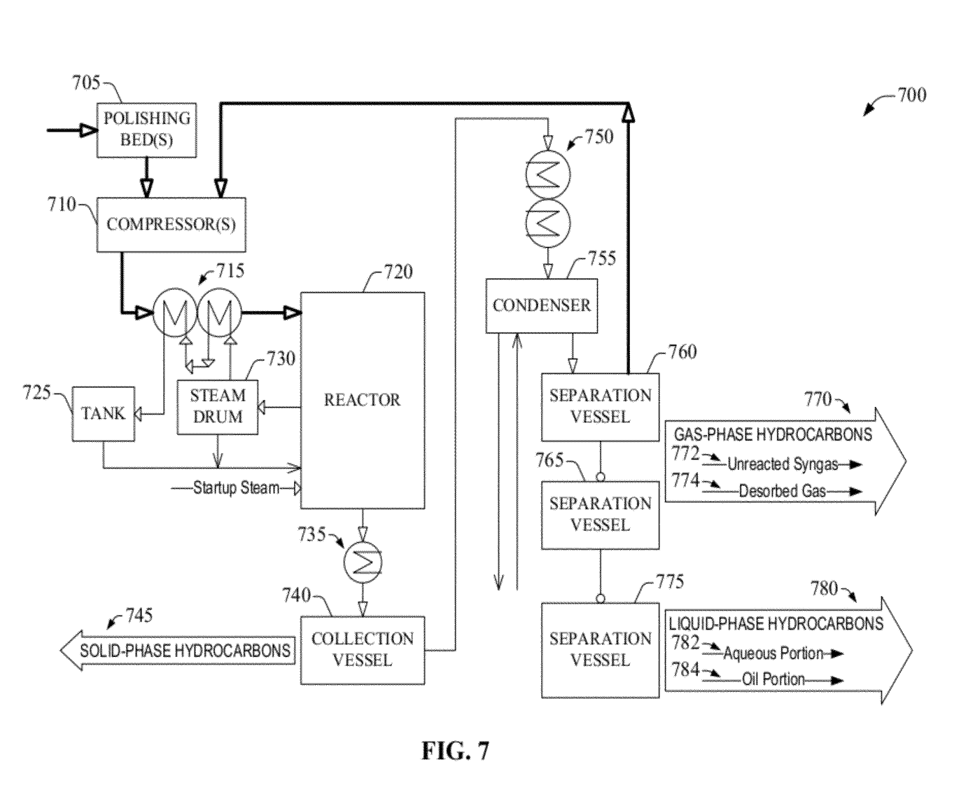

In one or more embodiments, such as the example embodiment illustrated in FIGS. 6A-6B, the pyrolysis chamber 506 is a vessel 602, with an inner surface coated, or lined, with a refractory material that can retain heat for the gasification of feedstock material; the refractory material is represented with right-slanted dashed area in FIGS. 6A-6B. The vessel 602 is a source of the heat for the gasification of the feedstock material; e.g., vessel 602 operates as a furnace. The refractory material can insulate the interior cavity 604 of the vessel from the outer environment. In addition, the refractory material can be a solid with physical properties (thermal coefficient(s), elastic moduli, hardness, etc.) suitable for operation in a high-pressure (e.g., from about 25 psi to about 100 psi) and high-temperature (e.g., from about 1000° F. through about 1800° F.) environment. In an aspect, the vessel 602 is manufactured out of metal (alloyed or otherwise) and is dimensioned to enable transportation of pyrolysis chamber 506 in any or most any conventional road; for instance, length of pyrolysis chamber 506 along axis 609 can range from about 30 foot (ft) to about 60 foot, whereas width ranges from nearly 10 ft to nearly 12 ft and height ranges from about 10 foot to about 12 foot. Any other materials suitable for withstanding elevated pressures (e.g., from nearly 25 psi to nearly 100 psi) also can be utilized.

The vessel 602 is also can be coated with thermally insulating material; a suitable amount of the thermally insulating material can be installed to ensure a substantive lower temperature in the environment outside vessel 602 when compared with the operating temperature inside vessel 602. In FIGS. 6A-6B, the thermally insulating material can be a portion of the right-slanted dashed area.

Pyrolysis chamber 506 also includes an injection structure 607 (e.g., an injection chamber) that collects an amount of feedstock material to be supplied to metal drum 608. Injection structure 607 is functionally coupled to accumulation chamber 504; in an aspect, functional coupling is accomplished through direct attachment via one or more suitable means (e.g., welding, bolting, etc.). In additional or alternative embodiments, the injection structure 607 is part of the accumulation chamber 504. Attached to the injection structure 607 is a conduit 611 (e.g., pipe(s), tube(s), valve(s), or the like) that can receive specific amount(s) of steam at a predetermined controllable pressure to adjust moisture level, or content, of the amount of feedstock material that is introduced in metal drum 608 for gasification (e.g., primary gasification phase 120). The specific amount(s) of steam that are received through the conduit 611 can be based on various characteristics of the feedstock material 110, such as the amount of feedstock material 110 or the moisture level of the feedstock material 110. In one or more modes of operation accomplished in certain embodiments, conduit 611 also allows injection of water into the amount of feedstock material in the injection chamber 607; as described supra, in one or more scenarios, the water can be injected in a specific water-to-solid ratio ρ; e.g., ρ can range from about 1 to about 1.5. The specific value of the water-to-solid ration r depends at least in part on amount of carbon that is present in feedstock material 110. The conduit 611 can be attached to injection structure 607 by any suitable means (welding, bolting, etc.), and can be manufactured out of metal.

A group of one or more heating elements 612 (represented with grey-shaded rectangles in FIG. 6A) provide heat to the environment in cavity 604, which transfers heat to the metal drum 608 within the vessel 602. In the illustrated example embodiment, the group of one or more heating elements consists of five heating elements 612; however, it is noted that the number of heating elements is configurable and determined based at least on heat flow necessary to achieve a desired temperature that allows to gasify, at least in part, a specific amount of feedstock material 110 supplied to the pyrolysis chamber 506. In alternative or additional embodiments, a group of 56 heating elements can be deployed. In a scenario in which one or more sealed radiant tubes are utilized as heating element, relatively low BTU (British Thermal Unit) value process, or product, gas can be employed for combustion and source of heat.

Metal drum 608 houses feedstock material and has cylindrical symmetry or is substantially cylindrically symmetric; see, e.g., FIG. 6A. Metal drum 608 can rotate about its axis of symmetry or substantial symmetry, such axis is illustrated with a dot-dashed line and labeled as axis 609 in FIG. 6A; rotation can increase heat transfer amongst the feedstock material and increase efficiency of the primary gasification phase (e.g., 120). For a cylindrical metal drum, the axis of symmetry is the longitudinal axis of the cylindrical metal drum. A variable speed motor drive 610 provides the torque that enables rotational motion of metal drum 608. In addition, the variable speed motor drive 610 allows to control and to change the angular velocity of such rotational motion. Change or variation of the angular velocity of the rotational motion of metal drum 608 allows regulation of retention time (e.g., Δτ_{P}) of feedstock material within pyrolysis chamber 506 for primary gasification phase (e.g., 120). In alternative embodiments, a dedicated variable speed motor drive enables regulated rotation (e.g., angular velocity is varied and controlled to be within a predetermined range of fluctuation) of metal drum 608.

Metal drum 608 includes a set of openings (not shown) for release of feedstock byproduct (not shown) via discharge structure 618. In addition, metal drum 608 includes a flight structure comprising one or more sets of flights; such structures are represented as crossed segments in FIG. 6B. Discharge structure 618 (not shown in FIG. 6B) is suitably manufactured to partially wrap around metal drum 608 to enable collection of the feedstock byproduct. Discharge structure 518 is terminated with one or more air-lock valves (black short segments) and an accumulation chamber 628.

In the embodiment illustrated in FIG. 6A, a set of five exhaust pipes, or gas collection pipes 632, stream any produced gas (e.g., 124) out of the pyrolysis chamber 506; the streamed gas is pyrolysis gas. It should be appreciated that the number of exhaust pipes can be different in additional or alternative embodiments.

In example gasification system 500, as a result of primary gasification, pyrolysis chamber 506 supplies gas (e.g., pyrolysis gas) to a steam reformation reactor 530, the gas (e.g., pyrolysis gas) is provided at elevated pressure P_{P}, e.g., a pressure in the range from about 25 psi to about 100 psi. The supplied gas (e.g., pyrolysis gas) is represented with a set of open arrows in FIG. 5. The steam reformation reactor 530 can be embodied, in part, in a set of metal coils that receive steam from steam source(s) 540. The elevated pressure P_{P} (e.g., at least about 25 psi) at which gas (e.g., pyrolysis gas) is produced in the pyrolysis chamber 506, as part of primary gasification phase, enables the syngas to circulate through the set of metal coils. The set of metal coils are designed and constructed to allow a predetermined resonance, or residency, time Δτ_{R} during which the reaction with steam is sustained. In one or more embodiments, Δτ_{R}≦10 s, e.g., 3 s≦Δτ_{R}≦5 s; in additional or alternative embodiments Δτ_{R} can be about 10 s. In one or more embodiments, the metal employed in a coil can be a simple metal, while in additional or alternative embodiments, the metal employed to manufacture a coil in the set of coils can be a high-temperature alloy, with suitable physical properties, such as high-temperature tensile strength and abrasion resistance. It is noted, however, that any simple metal or alloyed metal can be utilized to manufacture the set of metal coils. The steam reformation reactor 530 also can include a structure that allows size fluctuations or shape fluctuations of the set of metal coils in one or more directions and constrain deformations in a disparate direction. In addition, the steam reformation reactor 530 operates at a specific temperature (T_{R}) and with a predetermined partial pressure of steam, which generally is superheated steam. The temperature T_{R} generally is above the temperature at which primary gasification phase is conducted in pyrolysis chamber. For example, in certain embodiments, T_{R} is greater than about 1700° F. In additional or alternative embodiments, T_{R} is at least 1200° F. In certain embodiments, T_{R} is. Steam reformation results in reacted syngas that has a predetermined molecular-hydrogen-to-carbon-monoxide (H₂/CO) molar ratio, which is regulated, in part, by T_{R} and partial pressure of superheated steam. In an aspect, the syngas incoming in the steam reformation reactor 530 is reacted to saturation; namely, T_{R} and partial pressure of steam, or ratio of steam to carbon, are configured to values that yield the ideal or nearly ideal H₂/CO molar ratio for the syngas that is reacted. It should be appreciated that the ideal or nearly ideal H₂/CO molar ratio for the syngas that is reacted depends in part on the type of intended application of such syngas; for instance, if the reacted syngas is intended for liquid fuels, H₂/CO molar ratios from about 1.5:1 to 2.5:1 are nearly ideal or ideal.

In one or more embodiments, the steam source(s) 540 can include a boiler and additional structure to recover dissipated heat (e.g., heat from exhaust conduit(s) or pipes) from one or more of the pyrolysis chamber 506, solids reactor 510, and steam reformation reactor 530. Water for generation of steam can be supplied at least from a water recuperation feedback circuit that is part of a syngas cleaning phase. As an example, water can be collected from a condenser 560 and a water cleansing circuit that includes tank 570, filter(s) 580, and tank 595. In an aspect, condenser 560 reduces temperature and removes at least a portion of moisture of clean saturated syngas received from a wet scrubber that is part of the cleaning platform 550; in certain scenarios, temperature of the clean saturated syngas is reduced to at least about 75° F. Removed moisture is streamed into accumulation tank 570 for subsequent filtering and recuperation in tank 595.

In example gasification system 500, syngas produced in the solids reactor 510 can be conveyed to steam reformation reactor 530, whereas the disposable material (e.g., 138) can be discarded through disposal structure 520. Deployment (e.g., installation, testing, acceptance, and maintenance) of disposal structure 520 increases duration of the example multi-phase gasification system 500 through mitigation of transfer of disposable solids (ash, tar, mineral impurities, etc.) through steam reformation reactor 530; particularly, though not exclusively, through the set of metal coils. In an embodiment, the disposal structure 520 is a coolant-jacketed auger that removes, or ejects, the disposable material (e.g., 138) at a discharge end of solids reactor 510. The coolant can be water (at ambient temperature or refrigerated) or other liquid fluid that extracts heat as the auger ejects the disposable solids; the material of the auger can be substantially any simple metal, metal alloy, or ceramic alloy with physical properties suitable for operation in a high-pressure, high-temperature and high-abrasion environment. A set of air-lock valves 522 maintain operating pressure, e.g., a pressure in the range from nearly 25 psi to nearly 100 psi, of the solids reactor 510 in accumulation vessel 524 as the coolant-jacketed auger operates. As described supra, the set of air-lock valves 522 and accumulation vessel 524 mitigate (i) uncontrolled oxidation and ensuing combustion of the disposable material and (ii) uncontrolled ejection of the high-pressure disposable material. Similarly to accumulation chamber 504, accumulation vessel 524 includes at least one control valve that holds positive pressure (e.g., a pressure in the range of about 25 psi to about 100 psi) when the disposal material is released to the accumulation vessel 524. The at least one control valve also enables decompression of the accumulation vessel 524.

Syngas that is reacted in the steam reformation reactor 530 is conveyed to a cleaning platform 550 as part of a cleaning phase (e.g., 160). The cleaning platform 550 can include one or more of a set of scrubbing apparatus(es) (a wet scrubber, a dry scrubber, a filter etc.) or a set of cyclones; wherein the one or more cyclones in the set of cyclones can be employed for ash separation. In the illustrated example gasification system, cleaning platform 550 includes a wet scrubber, which can be a Venturi wet scrubber that exploits a liquid coolant, such as water, and can remove a substantive amount (e.g., 90-95%) of particles with typical sizes of the order of a micrometer or smaller; e.g., particulate matter with sizes below 1 μm. Operating pressure (e.g., about 25 psi to about 100 psi) in example non-combustion gasification system 500 can convey scrubbing water to accumulation tank 570, or accumulation tank 570. Collected water can be filtered through filter(s) 580, which can include screen filter(s), dual-media sand filter(s), bag filter(s), or the like. Recycled, filtered scrubbing water is circulated through cooling tower structure 590 (also referred to as cooling tower 490 in the subject disclosure) and collected in tank 595 (or accumulation tank 595). Condenser 560, filter(s) 580, and accumulation tank 595 form at least part of a water recuperation circuit which is closed by the wet scrubber that is part of cleaning platform 550 and accumulation tank 570. Recuperated or recycled water can be reintroduced in the wet scrubber in cleaning platform 550. In addition, as indicated supra, recycled water can be utilized for steam generation.

In addition, and in contrast to certain conventional gasification systems for production of syngas, the multi-phased gasification process (e.g., 100) and related example multi-phased gasification system 500 described herein can produce syngas without reliance in complex materials, such as ionized, electrostatically enhanced water, or complex structures such as those that provide ionized, electrostatically enhanced water or other types of chemically processed water.

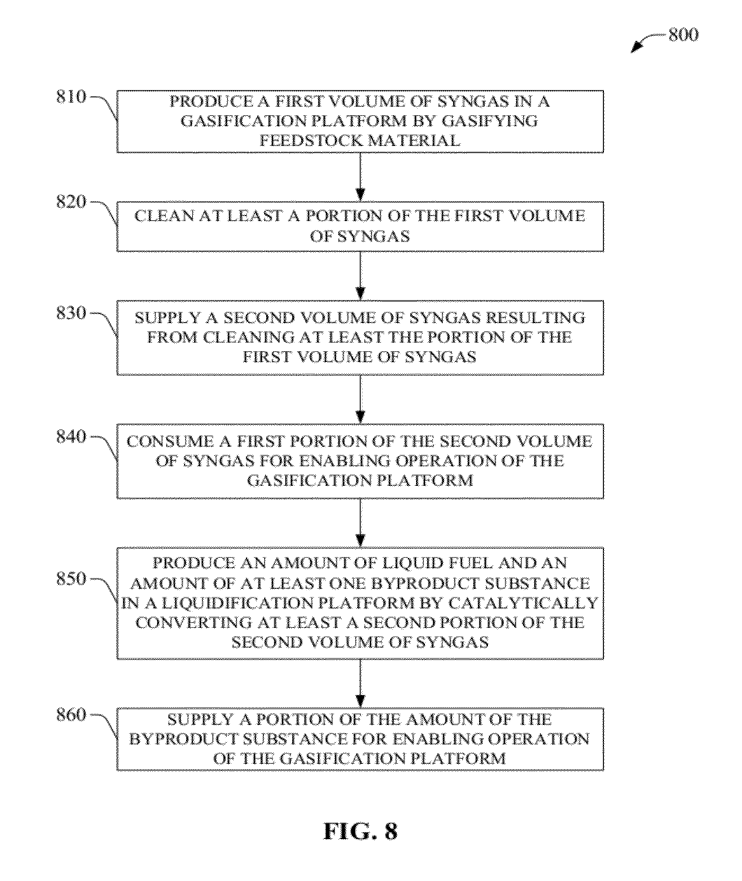

FIG. 7 is a block diagram of an example embodiment 700 of a liquidification platform 140 that enables implementation of the liquidification stage described hereinbefore in connection with FIG. 1. Clean syngas 130 is injected into polishing bed(s) 705, which removes impurities (e.g., sulfur) from the at least a portion of the clean syngas 130; such impurities can reduce lifetime of catalyst employed in catalytic conversion of syngas into liquid fuel. At least the portion of the clean syngas 130 is polished for a time interval Δτₚₒₗ. In an aspect, clean syngas 130 is injected into the polishing bed(s) 705 at a pressure of about 50 psi and a temperature of nearly 60° F., and Δτₚₒₗ is at least about 5 seconds. In certain operation scenarios, polishing bed(s) 705 can remove trace amounts (e.g., less that about 0.1 ppmV) of sulfur entrained in at least the portion of the clean syngas 130 that is polished. Reaction of such syngas with a mixed-metal oxide allows removal of the trace amounts of sulfur; the reaction yields a stable metal sulfide that can be recovered in accordance with various conventional procedures.

Polished syngas (or feed syngas) is injected into one or more compressor(s) 710 to achieve a pressure (e.g., about 410 psi) suitable for liquidification. In certain implementations, the one or more compressor(s) 710 include a 3-stage compressor with inter-stage cooling that compresses the polished syngas to a pressure of about 300 psi and maintains the polished syngas at a temperature of about 60° F. The 3-stage compressor is functionally coupled to a disparate compressor that enables a fourth compression stage in which syngas compressed in the 3-stage compressor is mixed with a volume of recycled syngas, and the mixture is cooled and compressed to a pressure of about 410 psi. In certain embodiments, the recycled syngas is injected into the one or more compressor(s) 710 at a pressure of about 355 psi and a temperature of nearly 65° F. Such recycled syngas is part of byproduct substances produced in accordance with aspects described herein. In certain implementations, the ratio of recycled syngas to polished syngas is nearly 3:1 on a standard volume basis. As a result of compression, the mixture of feed syngas and recycled syngas exits the one or more compressor(s) 710 at a temperature of about 117° F. In addition, a waste stream (not shown in FIG. 7) is ejected from the one or more compressor(s) 710, the waste stream comprising adsorbed gases (e.g., CO₂) and liquids (e.g., water) entrained in the syngas that is compressed. It should be appreciated that other types and functional deployment of compressor can embody the one or more compressor(s) 710 and can compress syngas to pressures suitable for liquidification through catalytic conversion.

Compressed syngas is circulated through and heated in a heat exchanger 715, in which the compressed syngas attains a pressure of about 400 psi and a temperature of about 405° F. The heated, compressed syngas is and supplied to a reactor 720 for catalytic conversion in to liquid fuel. In an implementation, reactor 720 is a steam-raising reactor with multi-tubular, fixed-bed structure in which the catalytic reaction and related conversion of syngas occurs. As an example, the multi-tubular structure in reactor 720 includes a plurality of stainless steel tubes loaded with a catalyst and arranged in a hexagonal lattice, or a honeycomb pattern; each tube in the plurality of tubes has a length in the range from nearly 15 ft. to nearly 40 ft. Exothermic heat of reaction is transferred to water that flows through the reactor 720; in aspect, the water is pressurized and can flow through the reactor via, for example, a jacket or shell surrounding the multi-tubular structure. Pressure of the water is regulated so as to achieve a saturation temperature of the coolant and a heat transfer rate that results in a catalyst temperature T_{cat} that is suitable for the catalytic conversion of the injected syngas; for certain catalysts, T_{cat} is about 430° F. It should be appreciated that coolants other than water also can be utilized to remove exothermic heat of reaction.

Tank 725 serves as deareator tank and source of coolant, such as water. Feed water (e.g., make-up water and condensate return(s)) water and from steam drum 730 are injected into reactor 720. As a result of heat exchange within the reactor 720, water transitions into steam and is ejected from the reactor 720 into the steam drum 730. An amount of steam is ejected into heat exchanger 715 from the steam drum 730; steam and water mixture exits the heat exchanger 715 into tank 725.

The product of catalytic conversion of syngas is a hydrocarbon product comprising solid-phase hydrocarbons, liquid-phase hydrocarbons, and gas-phase hydrocarbons. The hydrocarbon product is ejected from the reactor 720 at a temperature of nearly T_{cat} (e.g., about 430° F.) and circulated through a first heat exchanger 735 in which the hydrocarbon product is cross exchanged therein with a stream of recovered heat and the temperature of the hydrocarbon product is reduced to about 350° F. In an aspect, the hydrocarbon product is ejected from the reactor 720 at a pressure of nearly 380 psi. Cooling of the hydrocarbon product to such temperature yields solid-phase hydrocarbons comprising long-chain hydrocarbon (e.g., C₂₅ or longer) or Fischer-Tropsch (FT) waxes, and water vapor, lighter hydrocarbons, and unreacted syngas. In another aspect, FT waxes are produced at a temperature of about 350° F. and a pressure of about 375 psi. Collection vessel 740 receives the solid-phase hydrocarbons 745 and can supply an amount thereof. As described supra, solid-phase hydrocarbons 745 can be reintroduced, via a resource feedback circuit, to the feedstock material input stage in order to adjust the feedstock material moisture content to a desired level.

The lighter hydrocarbons and unreacted syngas are injected into a second heat exchanger 750 in which temperature is reduced to at least about 240° F. Output of the second heat exchanger is injected into a condenser 755 in which the temperature of lighter hydrocarbons and unreacted syngas is further reduced to at least about 100° F. utilizing chilled water as coolant or condensing agent. In one or more implementations, heat exchangers described herein are manufactured out of stainless steel based on durability considerations and expected contact with syngas.

Output of condenser 755 is injected into separation vessel 760, which operates at a first pressure and separates liquids from gases. The gases comprise unreacted syngas; in an aspect, about 98 volume-percent is recycled to the one or more compressor(s) 710, whereas the balance of unreacted syngas is utilized as described above Liquids are depressurized and supplied to separation vessel 765, which operates at a second pressure that is lower than the first pressure. Such pressure reduction releases adsorbed gases from the liquids; the adsorbed gas are mixed with purged unreacted syngas and collected into a stream of gas-phase hydrocarbons 770. In certain scenarios, temperature of a stream of gas-phase hydrocarbons 770 is nearly 80° F. and pressure is about 108 psi. As a result of recycling unreacted syngas into the gas conditioning phase of the liquidification stage, the gas-phase hydrocarbons 770 can have substantially the same BTU per standard cubic foot as that of product syngas generated in the gasification stage. A first portion of gas-phase hydrocarbons 770 can be supplied as tailgas through a first inter-platform resource feedback circuit for fueling burners of (i) gasification chamber(s) (e.g., pyrolysis unit 204) utilized in gasification phase or (ii) steam reformation reactors (e.g., steam reformation unit) in steam reformation phase. In addition or in the alternative, a second portion of gas-phase hydrocarbons 770 can be supplied as tailgas through a second inter-platform resource feedback circuit for injection into steam reformation phase for production of reacted syngas. As another alternative, at least a portion of gas-phase hydrocarbons 770 can be supplied as tailgas for power generation in a reciprocating gas engine generator set (e.g., external power generator(s) 180) or turbine.

Liquids that are degassed in separation vessel 765 are supplied to separation vessel 775. The liquids include hydrocarbons, alcohols, water, and entrained gases; in an aspect, temperature of the liquids range from about 60° F. to about 90° F., and the pressure of the liquids is about 365 psi; in certain embodiments, temperature of the liquids can be about 80° F. Separation vessel 775 yields at least liquid-phase hydrocarbons 780 comprising an aqueous portion 782 and an oil portion 784. In certain implementations, separation vessel 760 and separation vessel 765 are manufactured out of stainless steel, whereas separation vessel 775 is manufactured out of carbon steel. Moreover, separation vessel 775 is an oil/water parallel-plate flow separator. The aqueous portion 782 includes water and light miscible alcohols, while the oil portion 782 includes an amount of oil-soluble alcohols (e.g., butanol) and liquid hydrocarbon fuel. The oil portion 782 is directly consumable diesel fuel and primary biofuel (e.g., liquid fuel 150) produced through the integrated system disclosed herein. The diesel fuel can be utilized in mixture with petroleum derived diesel or directly employed neat for specific applications.

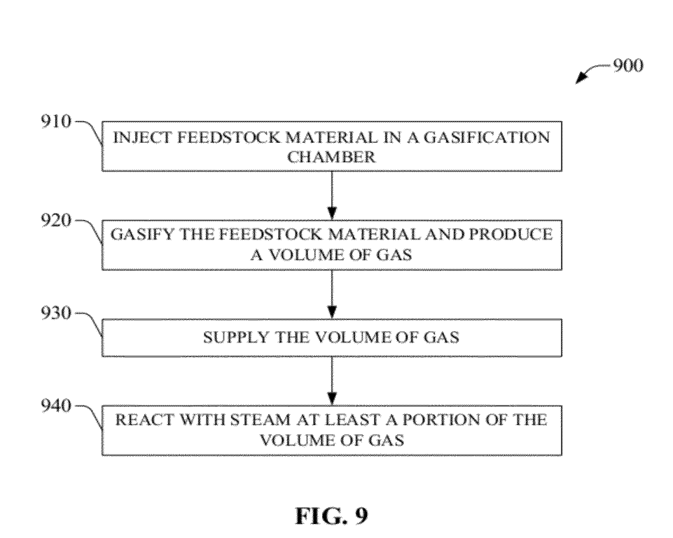

In view of the various example systems and platforms, and related embodiments, described above, example processes that can be implemented in accordance with the disclosed subject matter can be better appreciated with reference to flowcharts in FIGS. 8-12. For purposes of simplicity of explanation, example processes disclosed herein are presented and described as a series of acts; however, it is to be understood and appreciated that the disclosed subject matter is not limited by the order of acts, as some acts may occur in different orders and/or concurrently with other acts from that shown and described herein. For example, one or more example processes disclosed herein can alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example process in accordance with the subject disclosure. Further yet, two or more of the disclosed example processes can be implemented in combination with each other, to accomplish one or more features or advantages described herein.

FIG. 8 presents a flowchart of an example method 800 for producing liquid fuel from synthesis gas in an integrated platform according to aspects described herein. Example system 100 or various functional elements therein can implement the subject example method 800. At act 810, a first volume of syngas is produced in a gasification platform by gasifying feedstock material. As described supra, the gasification platform (e.g., gasification platform 120) can include at least one gasification chamber (e.g., pyrolysis chamber 406, which can be included in pyrolysis unit 204). At act 820, at least a portion of the first volume of syngas is cleaned. In certain embodiments, at least the portion of the first volume is cleaned in a cleaning platform (e.g., cleaning platform 450, which can be included in gas cleaning unit 212), which can have various degrees of complexity. In certain embodiments, the cleaning platform includes at least one scrubbing apparatus (wet scrubber, dry scrubber, etc.) or other cleaning structure, such as one or more cyclones. In such embodiments, the other cleaning structure can be functionally coupled to the at least one scrubbing apparatus for cleaning syngas. At act 830, a second volume of syngas is supplied, the second volume of syngas resulting from cleaning at least the portion of the first volume of syngas. At act 840, a first portion of the second volume of syngas is consumed for enabling operation of the gasification platform. In an embodiment, recycling circuits (e.g., resource feedback circuit(s) 160) enable consuming the first portion of the second volume of syngas. At act 850, an amount of liquid fuel and an amount of at least one byproduct substance are produced in a liquidification platform (e.g., liquidification platform 140) by catalytically converting a second portion of the second volume of syngas. At act 860, a portion of the amount of the at least one byproduct substance is supplied for enabling operation of the gasification platform.

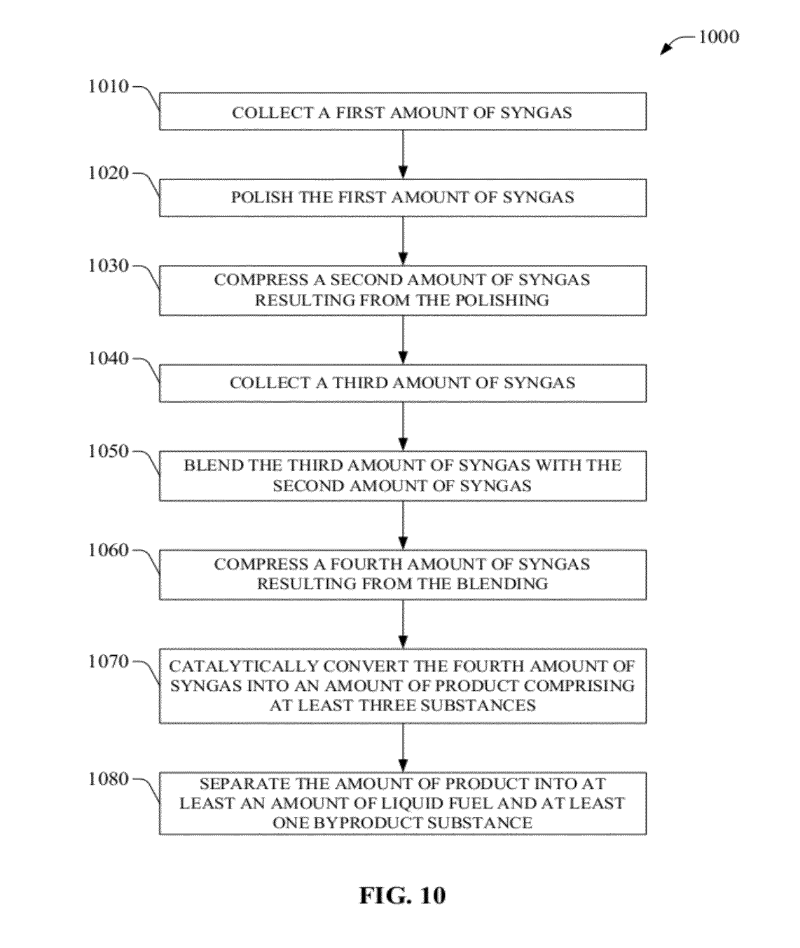

FIG. 9 presents a flowchart of an example process 900 for producing synthesis gas through non-combustion gasification of feedstock in accordance with aspects of the subject disclosure. At least a part (e.g., one or more acts) of the subject example process 900 can be effected in batch mode with a high interval operation (e.g., a short batch time span, such as about 1 min to about 10 min), in semi-continuous mode, or in continuous mode. In addition, in an aspect of the subject example method, the gasification of feedstock is accomplished through non-combustion gasification process(es), such as pyrolysis; however, it should be appreciated that other thermodynamic process(es) for gasification also can be utilized. At act 910, feedstock material is injected in a gasification chamber. The gasification chamber can be part of the gasification platform of act 810. In certain embodiments, the gasification chamber is embodied in one or more pyrolysis chambers. As described supra, injecting the feedstock material can include removing air there from, to ensure the gasification does not include combustion reactions which can produce tars and other oxidant-based contaminants. In addition, in one or more embodiments, the injecting can include injecting a volume of steam into the gasification chamber; injecting the volume of steam allows controlling, to certain degree, the composition of produced synthesis gas during gasification. The volume of steam can be superheated at a temperature of at least 1200° F. Moreover, as described supra, the injecting can include mixing the feedstock material with water in a specific water-to-solid ratio ρ (with ρ a real number); from example, ρ can range from nearly 1 to nearly 1.5. At act 920, the feedstock material is gasified and a first volume of gas is produced. The feedstock material is gasified at a first temperature and a first pressure, wherein the first temperature ranges from about 1000° F. to about 1750° F. and in the range from about 25 psi to about 100 psi. In an aspect, as described supra, if gasifying the feedstock material is accomplished in one or more pyrolysis chambers (see, e.g., FIGS. 4 and 5A), the gas in the first volume of gas is pyrolysis gas, which includes synthesis gas and other gases comprising heavier molecules.

At act 930, the first volume of gas (e.g., pyrolysis gas) is supplied. In an aspect, the supplying includes releasing the first volume of gas (e.g., pyrolysis gas) into a reactor for steam reformation via a set of gas collection structures, such as pipes and regulation valves (see, e.g., FIG. 4). At act 940, at least a portion of the first volume of gas (e.g., pyrolysis gas) is reacted with steam within the reactor for steam reformation (e.g., reactor 430). As discussed supra, the first volume of gas (e.g., syngas) is reacted with a volume of superheated steam at a reaction temperature T_{R} for a predetermined time Δτ_{R}. The supplying act 930 also can include streaming, or delivering, at least a first portion of clean syngas into one or more combustion lines (e.g., burners) that produce heat for gasification phase(s), steam reformation, and other processes that can be part of the multi-phase gasification of feedstock described herein.

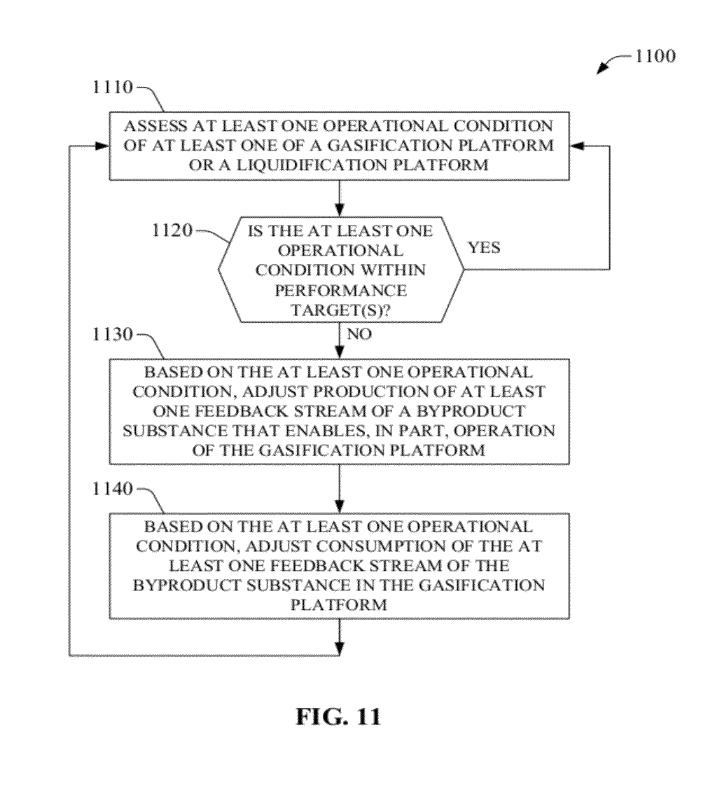

FIG. 10 is a flowchart of an example method 1000 for producing liquid fuel and related byproduct substance(s) according to aspects described herein. In certain implementations, the subject example method 1000 can embody act 840. At act 1010, a first amount of syngas is collected and, at act 1020, such first amount is polished. As discussed supra, in an aspect, the first amount of syngas is clean syngas produced in a gasification platform (e.g., gasification platform 120). Polishing the first amount of syngas can be accomplished in equipment (e.g., gas preparation unit 304) that conditions, at least in part, syngas for fuel synthesis. The polishing act 1010 includes removing an amount of impurities (e.g., sulfur) from the first amount of syngas. At act 1030, a second amount of syngas is compressed, wherein the second amount of syngas results from the polishing at act 1010. Generally, compressing the second amount of syngas can be accomplished in the equipment (e.g., gas preparation unit 304) that conditions syngas for fuel synthesis. In certain embodiments, the second amount of syngas can be compressed in a multi-stage compressor with a set of inter-stage coolers. At act 1040, a third amount of syngas is collected. In an aspect, the third amount of syngas can be a byproduct substance produced during liquid fuel synthesis and recycled in accordance with aspects of the subject disclosure. In particular, though not exclusively, the third amount of syngas can be the result of effecting the subject example prior to collecting the first amount of syngas. At act 1050, the third amount of syngas is blended with the second amount of syngas. In certain embodiments, the blending includes injecting the third amount of syngas into a stage of the multi-stage compressor. At act 1060, a fourth amount of syngas resulting from the blending at act 1050 is compressed. At act 1070, the fourth amount of syngas is catalytically converted into an amount of product comprising at least three substances. At act 1080, the amount of product is separated into at least an amount of liquid fuel and at least one byproduct substance. As described supra, in an embodiment, a first substance is a gas phase hydrocarbon, a second substance is a solid phase hydrocarbon, and a third substance is a liquid phase hydrocarbon. In such embodiment, the amount of liquid fuel is at least part of the third substance (e.g., the liquid phases hydrocarbon).

In the subject example method 1000, acts 1020-1060 embody an example method for preparing synthesis gas for fuel synthesis in accordance with aspects of the subject disclosure. Various parameters such as intended concentration of impurities (sulfur, particulate matter, etc.), compression pressure, proportion of blended amounts of syngas are established specifically to enable suitable catalytic conversion of the synthesis gas in accordance with various aspects herein. In alternative embodiments, order of the acts 1020-1060 can be altered while producing syngas suitably prepared—according to the various parameters—for fuel synthesis.

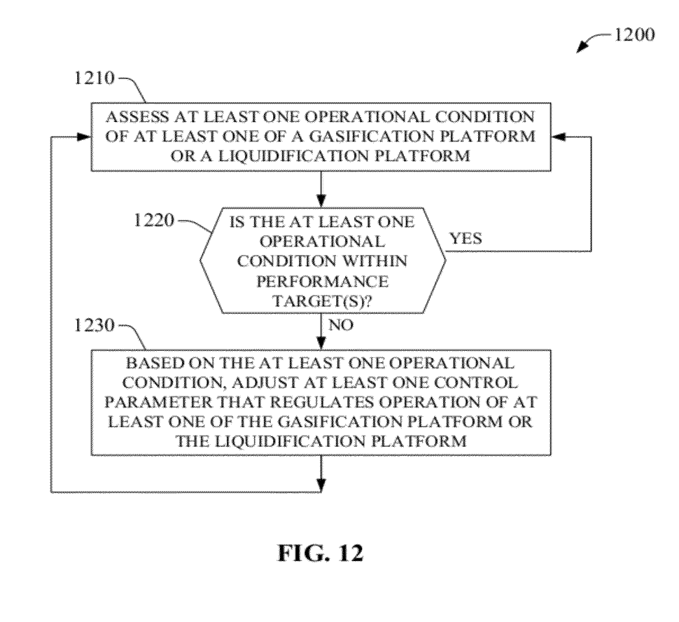

FIGS. 11-12 present, respectively, flowcharts of example methods 1100 and 1200 for integrating production of synthesis gas and synthesis of liquid fuels according to aspects of the subject disclosure. A control platform (e.g., assessment platform 180) that is part of is functionally coupled to a gasification platform (e.g., gasification platform 120) or a liquidification platform (e.g., liquidification platform 140) can implement the subject example methods 1100 and 1200. Regarding example method 1100, at act 1110, at least one operational condition of at least one of the gasification platform or the liquidification platform is assessed. In an embodiment, equipment (pressure gauges, flow gauges; spectroscopic sensors, such as mass spectrometers, optical spectrometers, photo-detectors . . . ; etc.) included in the control platform (e.g., assessment platform 180) can assess the at least one operational condition, as described in previous passages. The at least one operational condition can comprise (A) input condition(s), (B) processing condition(s), and (C) output condition(s), as described in a preceding passage. In an example scenario, the at least one condition is composition of product syngas (e.g., clean syngas 130) and production volume of the product syngas. In an aspect, assessing the at least one operational condition of at least one of the gasification platform or the liquidification platform includes measuring moisture content of feedstock material injected into the gasification platform. In certain embodiments, measuring such moisture content includes performing measurements of (or measuring) the moisture content in real-time or in nearly real-time. In another aspect, assessing the at least one operational condition of at least one of the gasification platform or the liquidification platform includes measuring a volume of an aqueous portion (e.g., a waxy water portion) of liquid-phase hydrocarbons (e.g., 780) produced in the liquidification platform. In certain embodiments, measuring such volume includes performing measurements of (or measuring) the volume in real-time or in nearly real-time. In another aspect, assessing the at least one operational condition of at least one of the gasification platform or the liquidification platform includes measuring volume and composition of tailgas, or gas-phase hydrocarbons (e.g., 770) produced in the liquidification platform. In certain embodiments, measuring such volume and composition includes performing measurements of (or measuring) the volume and composition in real-time or in nearly real-time. In yet another aspect, assessing the at least one operational condition of at least one of the gasification platform or the liquidification platform includes measuring volume and composition of product syngas (e.g., syngas 130). In certain embodiments, measuring such volume and composition includes performing measurements of (or measuring) the volume and composition in real-time or in nearly real-time.

At act 1120, it is determined if the at least one operational condition is within performance target(s). Performance target(s) can include a set of thresholds that establish intended, or target, performance condition(s); the set of thresholds can include one or more of a first subset of one or more thresholds related to input condition(s), a second subset of one or more thresholds related to processing condition(s), or a third subset of one or more thresholds related to output condition(s). In the example scenario referred to above, the performance target(s) can be configured (e.g., defined) to establish a target composition of product syngas (e.g., clean syngas 130) and a target production volume of the product syngas. In an aspect, determining if the at least one operational condition is within performance target(s) include comparing at least one value of at least one variable related to the at least one performance condition and, based on outcome of the comparing, classifying the at least one performance condition as within performance target(s) or outside performance target(s). For example, when the at least one value of the at least one variable related to the at least one performance condition is above or equal or nearly equal at least one threshold related to the at least one performance condition, the at least one condition can be determined to be within performance target.

At act 1130, based on the at least one operational condition, production of a feedback stream of a byproduct substance is adjusted, wherein the byproduct substance, e.g., syngas or tailgas, aqueous portion of produced liquid-phase hydrocarbons, or the like, enables, in part, operational of the gasification platform. In certain embodiments, adjusting the production of the feedback stream of the byproduct substance leads, in response, to reducing an external energy source (e.g., natural gas) for operating the gasification platform (e.g., igniting a group of burners that provide heat to gasification platform 120). At act 1140, also based on the at least one operational condition, consumption of the feedback stream of the byproduct substance in the gasification platform is adjusted. In an aspect, adjusting consumption of the feedback stream of the byproduct substance in the gasification platform can include reducing or terminating consumption of an external source of energy (e.g., natural gas) and increasing consumption of tailgas. In another aspect, adjusting such consumption can include reducing or terminating consumption of a volume of externally supplied water and increasing a volume of waxy water (e.g., aqueous portion 782). In an integrated system for production of liquid fuel through syngas (e.g., example system 100), such feedback stream is produced in a liquidification platform of the integrated system and consumed in a gasification platform within such integrated system. In response to adjusting such consumption, flow is directed to act 1110, in which operational condition(s) are assessed and further adjusting can be implemented in accordance with the subject example method 1100.

In connection with example method 1200, at act 1210, at least one operational condition of at least one of a gasification platform or a liquidification platform is assessed. The subject act is substantially the same as act 1110. At act 1220, it is determined if the at least one operational condition is within performance target(s), wherein the performance target(s) can include a set of thresholds that establish intended, or target, performance condition(s); the set of thresholds can include one or more of a first subset of one or more thresholds related to input condition(s), a second subset of one or more thresholds related to processing condition(s), or a third subset of one or more thresholds related to output condition(s). Act 1220 is substantially the same as act 1120. In a scenario in which outcome of act 1220 is affirmative, flow is directed to act 1210. In the alternative, flow is directed to act 1230.

At act 1230, based on the at least one operational condition, at least one control parameter (temperature, pressure, flow of stem, rate of feedstock loading, etc.) that regulates operational of at least one of the gasification platform or the liquidification platform is adjusted. In an aspect, adjusting the at least one control parameter that regulates operational of at least one of the gasification platform or the liquidification platform can include adjusting a temperature profile, e.g., temperature setpoints at various instants, in a gasification unit (e.g., pyrolysis unit 204) in the gasification platform 120. In response to adjusting such consumption, flow is directed to act 1210, in which operational condition(s) are assessed and further adjusting can be implemented in accordance with the subject example method 1200.

As employed in the subject disclosure, the term “relative to” means that a value A established relative to a value B signifies that A is a function of the value B. The functional relationship between A and B can be established mathematically or by reference to a theoretical or empirical relationship. As used herein, “coupled” means directly or indirectly connected in series by wires, traces, pipes, tubes, or other conduits or connecting elements. Coupled elements may receive signals from each other.

In the subject disclosure, terms such as “store,” “data store,” data storage,” and substantially any term(s) that convey other information storage component(s) relevant to operation and functionality of a functional element (e.g., a platform) or component described herein, refer to “memory components,” or entities embodied in a “memory” or components comprising the memory. The memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of further illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Certain illustrative components or associated sub-components, logical blocks, modules, and circuits, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or acts described supra.

Further, certain steps or actions (or acts) of a process, method, or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, in some aspects, certain steps or acts of a process, method, or algorithm may reside as one or any combination or set of codes or instructions on a machine readable medium or computer readable medium, which may be incorporated into a computer program product.

While the foregoing disclosure discusses illustrative aspects and/or embodiments, it should be noted that various changes and modifications could be made herein without departing from the scope of the described aspects and/or embodiments as defined by the appended claims. In addition, although elements of the described aspects and/or embodiments may be described or claimed in the singular, the plural is contemplated unless limitation to the singular is explicitly stated. Moreover, all or a portion of any aspect and/or embodiment may be utilized with all or a portion of any other aspect and/or embodiment, unless stated otherwise. Furthermore, to the extent that the terms “includes,” “include,”, “has,” “have”, “possess,” “possesses,” and the like are used in the summary, detailed description, claims, appendices, and drawings such terms are intended to be inclusive in a manner similar to the term “comprising” as “comprising” is interpreted when employed as a transitional word in a claim.

What is claimed is:

1. A process, comprising:
producing a first volume of synthesis gas (syngas) in a gasification platform by gasifying feedstock material;
cleaning at least a first portion of the first volume of syngas;
supplying at least a second portion of a second volume of syngas resulting from the cleaning;
producing an amount of liquid fuel and an amount of at least one byproduct substance in a liquidification platform by catalytically converting at least the second portion of the second volume of syngas; and
supplying a portion of the amount of the at least one byproduct substance for enabling, at least in part, operation of the gasification platform.

2. The process of claim 1, wherein producing the first volume of syngas in the gasification platform by gasifying the feedstock material comprises:
injecting the feedstock material in a gasification chamber; and
gasifying the feedstock material in the gasification chamber, wherein the gasifying includes indirectly heating the gasification chamber to a first temperature and pyrolyzing the feedstock material at substantially the first temperature, wherein the first temperature is in a range from less than 600° F. to greater than 1750° F.

3. The process of claim 2, wherein producing the first volume of syngas in the gasification platform by gasifying the feedstock material further comprises:
reacting with steam an amount of the first volume of syngas.

4. The process of claim 2, wherein the injecting includes injecting the feedstock material with a moisture content ranging from about 20% to about 50%.

5. The process of claim 2, further comprising:
blending at least a third portion of a third volume of syngas resulting from the cleaning with the portion of the amount of the at least one byproduct substance, the at least one byproduct substance being a gas phase hydrocarbon; and
utilizing an amount of gas resulting from the blending for heating the gasification chamber.

6. The process of claim 1, further comprising:
blending at least a third portion of a third volume of syngas resulting from the cleaning with the portion of the amount of the at least one byproduct substance, the at least one byproduct substance being a gas phase hydrocarbon; and
utilizing an amount of gas resulting from the blending for generating steam for electrical production.

7. The process of claim 1, further comprising:
blending at least a third portion of a third volume of syngas resulting from the cleaning with the portion of the amount of the at least one byproduct substance, the at least one byproduct substance being a gas phase hydrocarbon; and
utilizing an amount of gas resulting from the blending for electrical production.

8. The process of claim 2, further comprising:
consuming at least the first portion of the first volume of syngas for heating the gasification chamber.

9. The process of claim 2, wherein the injecting includes:
measuring moisture content of the feedstock material; and
when the measuring indicates the moisture content is outside a range from about 20% to about 50%, blending the feedstock material with the portion of the amount of the at least one byproduct substance, the at least one byproduct substance being a gas phase hydrocarbon; wherein
the blending is performed until the feedstock material resulting from the blending has a moisture content within the range from about 20% to about 50%.

10. The process of claim 1, wherein producing the first volume of syngas in the gasification platform by gasifying the feedstock material comprises:
producing the first volume of syngas with a molar ratio of H₂-to-CO in a range from about 1.5-to-1 to about 2.5-to-1.

11. The process of claim 1, wherein producing the amount of liquid fuel and the amount of the at least one byproduct substance in the liquidification platform by catalytically converting at least the second portion of the second volume of syngas comprises:
preparing a first amount of syngas comprising at least the second portion of the second volume of syngas and a volume of syngas contained in the at least one byproduct substance;
catalytically converting the first amount of syngas into an amount of a hydrocarbon product comprising at least three substances; and
separating the amount of the hydrocarbon product into at least the amount of liquid fuel and the amount of the at least one byproduct substance.

12. The method of claim 11, wherein the preparing includes:
removing an amount of impurities from at least the second portion of the second volume of syngas;
compressing a second amount of syngas resulting from the removing;
blending the second amount of syngas with the volume of syngas contained in the amount of the at least one byproduct substance; and
compressing a third amount of syngas resulting from the blending.

13. The process of claim 1, further comprising:
assessing at least one operation condition of at least one of the gasification platform or the liquidification platform;
based at least on the at least one operation condition, adjusting production of the amount of the at least one byproduct substance in the liquidification platform; and
adjusting consumption of the amount of the at least one byproduct substance in the gasification platform.

14. A system, comprising:
a gasification platform that produces synthesis gas (syngas) through non-combustive gasification of feedstock material;
a liquidification platform that collects a first portion of the synthesis gas and catalytically converts the first portion of the synthesis gas into liquid fuel and at least one byproduct substance, wherein the at least one byproduct substance comprises a solid-phase hydrocarbon, a gas-phase hydrocarbon, and a liquid-phase hydrocarbon; and
a set of feedback circuits that supplies at least a portion of the at least one byproduct substance to the gasification platform.

15. The system of claim 14, wherein the gasification platform comprises:
a gasification unit comprising a gasification chamber that gasifies at least a portion of the feedstock material into at least a second portion of the syngas;
a steam reformation unit in which at least the second portion of the syngas is reacted with steam yielding an amount of saturated syngas; and
a gas cleaning unit that removes particulate matter from the amount of the saturated syngas and yields clean syngas.

16. The system of claim 15, wherein the gasification unit includes a feedstock supply unit that enables regulation of at least one of moisture content of the feedstock material or oxygen content of the feedstock material, and injects at least the portion of the feedstock material.

17. The system of claim 16, wherein the liquidification platform comprises:
a gas conditioning unit that collects an amount of the clean syngas and enables compression of a mixture of the amount of the clean syngas and an amount of unreacted syngas;
a fuel synthesis unit that catalytically converts at least a portion of the mixture yielding an amount of a hydrocarbon product; and
a product separation unit that processes the amount of the hydrocarbon product and yields an amount of the liquid fuel and an amount of the at least one byproduct substance.

18. The system of claim 17, wherein the amount of the at least one byproduct substance comprises an amount of the solid-phase hydrocarbon and an amount of the gas-phase hydrocarbon, and an amount of the liquid-phase hydrocarbon.

19. The system of claim 18, wherein the set of feedback circuits includes at least one feedback circuit that supplies at least a portion of the amount of the solid-phase hydrocarbon to the feedstock supply unit for adjusting moisture content of the feedstock material.

20. The system of claim 18, wherein the set of feedback circuits includes:
a first feedback circuit that supplies at least a portion of the amount of the gas-phase hydrocarbon to the gasification unit for fueling a heat source of the gasification chamber; and
a second feedback circuit that supplies at least a portion of the amount of the gas-phase hydrocarbon to the gasification unit for reaction with steam in the steam reformation unit.

21. The system of claim 18, wherein the set of feedback circuits includes at least one feedback circuit that supplies at least a portion of the amount of the gas-phase hydrocarbon to a set of power generators for producing electricity.

22. The system of claim 18, wherein the set of feedback circuits includes at least one feedback circuit that supplies at least a portion of the amount of the gas-phase hydrocarbon to the gasification unit for reaction with steam in the steam reformation unit.

23. The system of claim 18, wherein the set of feedback circuits includes at least one feedback circuit that supplies at least a portion of the amount of the liquid-phase hydrocarbon to the steam reformation unit for producing steam.

24. The system of claim 14, further comprising:
an assessment platform comprising a set of sensors that collect data related to at least one operational condition of the system, wherein the set of sensors include a first group of sensors distributed in the gasification platform and a second group of sensors distributed in the liquidification platform.

25. The system of claim 24, wherein based at least on a portion of the data, the assessment platform analyzes at least one of at least one physical property or at least one chemical property of the syngas.

26. The system of claim 16, wherein the feedstock supply unit enables air removal from at least the portion of the feedstock material.

27. The system of claim 15, wherein the steam reformation unit supplies a volume of steam to the gasification chamber, wherein the volume of the steam is based at least on moisture content of at least the portion of feedstock material.

28. The system of claim 16, wherein the feedstock supply unit enables injection of water into the feedstock material, wherein the injection of the water produces a specific water-to-solid ratio in the range from about 1 to about 1.5.

29. The system of claim 14, wherein the second portion of the syngas is supplied to the steam reformation unit at a gas pressure of at least about 25 psi.

30. A system, comprising:
means for producing in a gasification platform a first amount of synthesis gas (syngas);
means for cleaning at least a first portion of the first amount of syngas;
means for supplying at least a second portion of a second amount of syngas resulting from the cleaning;
means for converting in a liquidification platform at least the second portion of the second amount of syngas into an amount of liquid fuel and an amount of at least one byproduct substance, wherein the amount of the at least one byproduct substance comprises a first amount of a solid-phase hydrocarbon, a second amount of a gas-phase hydrocarbon, and a third amount of a liquid-phase hydrocarbon; and
means for supplying a portion of the amount of the at least one byproduct substance for enabling operation of at least one of the gasification platform or the liquidification platform.
